(19) United States
(12) Patent Application Publication
(10) Pub. No.: US 2024/0019408 A1
(43) Pub. Date: Jan. 18, 2024

(54) METHOD FOR DETECTING MONOSACCHARIDE AND OLIGOSACCHARIDE CONTENT AND FINGERPRINT SPECTURM OF COMPOUND SOPHORA FLAVESCENS INJECTION

(71) Applicant: BEIJING ZHENDONG GUANGMING PHARMACEUTICAL RESEARCH INSTITUTE CO., LTD., Shangdi, Haidian District Beijing (CN)

(72) Inventors: Xiumei DUAN, Shangdi, Haidian District Beijing (CN); Lina HAI, Shangdi, Haidian District Beijing (CN); Hongling WANG, Shangdi, Haidian District Beijing (CN); Wenjie QIN, Shangdi, Haidian District Beijing (CN); Hongyu WANG, Shangdi, Haidian District Beijing (CN)

(73) Assignee: BEIJING ZHENDONG GUANGMING PHARMACEUTICAL RESEARCH INSTITUTE CO., LTD., Shangdi, Haidian District Beijing (CN)

(21) Appl. No.: 18/255,302

(22) PCT Filed: Nov. 30, 2021
(86) PCT No.: PCT/CN2021/134502

§ 371 Date: May 31, 2023

(30) Foreign Application Priority Data
Dec. 3, 2020 (CN) 202011395666.3

(51) Int. Cl. G01N 30/36; G01N 30/74; G01N 30/06; G01N 30/86; B01D 15/16; B01D 15/12

(52) U.S. Cl. CPC G01N 30/36; G01N 30/74; G01N 30/06; G01N 30/8686; B01D 15/166; B01D 15/125; G01N 2030/027

(57) ABSTRACT

A method for detecting the monosaccharide and oligosaccharide content and fingerprint spectrum of a compound Sophora flavescens injection, comprising: carrying out detection by using a high-performance liquid chromatography-evaporation light scattering detection method, wherein the monosaccharides and oligosaccharides are D-anhydrous glucose, D-fructose, sucrose and pinitol. The present method is an improved method for detecting monosaccharides and oligosaccharides of a compound Sophora flavescens injection, and can measure four saccharide components in the compound Sophora flavescens injection at the same time, and constructs an HPLC-ELSD fingerprint spectrum to provide a technical method for the quality control of the saccharide components in the compound Sophora flavescens injection.

### TECHNICAL FIELD

The present application belongs to the field of pharmaceutical technology, and, in particular, relates to an improved HPLC method for detecting Compound Kushen Injection.

### BACKGROUND ART

Compound Kushen Injection is a traditional Chinese medicine injection refined by modern scientific methods from Sophora flavescens and Heterosmilax yunnanensis Gagnep. It has the effects of clearing heat, promoting dampness, cooling blood and detoxifying, dispersing nodules and relieving pain, and is used for cancer pain and bleeding. So far, research on Compound Kushen Injection has mainly focused on alkaloids and flavonoids, with relatively little research on saccharides. In recent years, traditional Chinese medicine saccharides, as a class of bioactive components, have multiple functions such as immune regulation, anti-tumor, antioxidant, hypoglycemic, and anti-lung cancer, and thus have become a hot research topic for various scholars. At present, there are few reports on the types and content of monosaccharides in Compound Kushen Injection in the literature: except for the HPLC-ELSD determination of pinitol content in Compound Kushen Injection published by Li Bowen et al. (Chinese Journal of Traditional Chinese Medicine Information, Vol. 21, Issue 2, February 2014, pp. 83-85), Liu Xiaoqian published her doctoral thesis Research on the Control Technology and Standard of the Production Process of Compound Kushen Injection&Exploration and Research on Reducing the Toxicity of vinorelbine by Liposome Technology, which measured the content of D-glucose anhydrous, there is no other literatures reciting the type and content of monosaccharides and oligosaccharides in Compound Kushen Injection.

Currently, a high-performance liquid chromatography is used in traditional Chinese medicine to detect the content of monosaccharides and oligosaccharides in an injection.

Patent CN103543222A discloses a method for detecting the content of saccharide components in Reduning Injection, which applies the HPLC-ELSD method to simultaneously determine the content of fructose and D-glucose anhydrous in Reduning Injection. However, in the chromatogram obtained by this method, the separation degree between fructose and D-glucose anhydrous is relatively small, and the pinitol with a retention time between fructose and D-glucose anhydrous cannot be separated. Therefore, this method cannot be used for the detection of carbohydrates in Compound Kushen Injection.

Zhang Xue et al. published the HPLC-CAD method for the simultaneous determination of monosaccharides and disaccharides in white ginseng (International Journal of Pharmaceutical Research, Vol. 45, Issue 2, February 2018, pp. 154-157). The method is separated using an Xbridge Amide chromatographic column, eluted with acetonitrile-0.2% ethylamine (78:22) at a flow rate of 1 ml/min, column temperature of 30° C., and internal temperature of the CAD detector of 30° C. to detect D-fructose, mannose, D-glucose anhydrous, and Sucrose. However, the inventor found through research that this method is not suitable for the determination of sugar components in Compound Kushen Injection. The main drawbacks include poor separation between various chromatographic peaks, excessive interference from other substances, inability to perform content determination, and unstable baseline.

Huang Qinwei et al. published a study on the quantitative determination of monosaccharide and oligosaccharide in Guanxinning injection (Traditional Chinese Patent Medicines, Vol. 34, Issue 7, July 2012, Pages 1299-1303). The method described is to use HPLC-ELSD method, with sugar group as the filler (Prevail Carbohydrate ES column 4 6 mm×250 mm and 5 μm); the mobile phase is acetonitrile and water (79:21); the volume flow rate of 1.0 mL/min; ELSD detector; drift tube temperature is 100° C.; N₂ flow rate is 2.8 L/min. However, the inventor found through research that this method is not suitable for the detection of saccharide components in Compound Kushen Injection. The main drawback lies in that the sample chromatogram detected by this method has a mixed chromatographic peak of fructose and pinitol, which cannot be separated at all. Therefore, using this chromatographic condition cannot be used for detecting pinitol, and the quantification of fructose is also not accurate.

Therefore, in order to accurately control the sugar components in Compound Kushen Injection, it is necessary to provide a method that can simultaneously determine the content and fingerprint of multiple sugar components in Compound Kushen Injection. The detection of sugar components in Compound Kushen Injection provides a fast and efficient detection method.

### SUMMARY

In response to the above technical status, the present application provides a method for detecting the content and fingerprint of a monooligosaccharide in Compound Kushen Injection. The method includes performing detection by using a high-performance liquid chromatography-evaporative light scattering detection method, in which the monooligosaccharide is D-glucose anhydrous, D-fructose, sucrose, and pinitol.

In the method according to the present application, as one of the embodiments, the chromatographic column in the high-performance liquid chromatography-evaporative light scattering detection method is a Prevail Carbo hydrogen ES column with a specification of 4.6 mm×250 mm, 5 μm.

In the method according to the present application, as one of the embodiments, the mobile phase in the high-performance liquid chromatography-evaporative light scattering detection method is a gradient solution of acetonitrile and water.

In the method according to the present application, as one of the embodiments, the gradient elution conditions in the high-performance liquid chromatography-evaporative light scattering detection method are as follows:

| Time (min) | Acetonitrile (%) | Water (%) |
|---|---|---|
| 0-25 | 85 | 15 |
| 25-30 | 85-70 | 15-30 |
| 30-45 | 70 | 30 |

In the method according to the present application, as one of the embodiments, the flow rate of the mobile phase in the high-performance liquid chromatography-evaporative light scattering detection method is 0.95-1.05 ml/min, preferably 1 ml/min.

In the method according to the present application, as one of the embodiments, the column temperature in the high-performance liquid chromatography-evaporative light scattering detection method is 13-20° C., preferably 15° C.

In the method according to the present application, as one of the embodiments, an injection amount of the low concentration reference substance and sample in the high-performance liquid chromatography-evaporative light scattering detection method is 10 μl. An injection volume of the high concentration reference substance is 20 μl.

In the method according to the present application, as one of the embodiments, the evaporation temperature of the evaporation light detector in the high-performance liquid chromatography-evaporative light scattering detection method is 59-61° C., preferably 60° C.

In the method according to the present application, as one of the embodiments, the atomization temperature of the evaporative light detector in the high-performance liquid chromatography-evaporative light scattering detection method is 59-61° C., preferably 60° C.

In the method according to the present application, as one of the embodiments, a carrier gas in the high-performance liquid chromatography-evaporative light scattering detection method is nitrogen gas, with a flow rate of 1.4-1.6 L/min, preferably 1.5 L/min.

In the method according to the present application, as one of the embodiments, a blank solution in the high-performance liquid chromatography-evaporative light scattering detection method is prepared with a mixed solution of acetonitrile-water=50:50, which is obtained.

In the method according to the present application, as one of the embodiments, a reference substance solution in the high-performance liquid chromatography-evaporation light scattering detection method is prepared by: accurately weighing an appropriate amount of D-fructose reference substance, pinitol reference substance, D-glucose anhydrous reference substance, and sucrose reference substance, adding a blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking, which is obtained; and preparing two copies using the same method.

In the method according to the present application, as one of the embodiments, the test substance solution in the high-performance liquid chromatography-evaporative light scattering detection method is prepared by accurately measuring 1 ml of individual batches of Compound is Kushen Injection, adding to a 20 ml volumetric flask, adding a blank solution to scale, shaking well, filtering, and taking a subsequent filtrate as the test substance solution.

In the method according to the present application, as one of the embodiments, the method for detecting the content of monosaccharides in the Compound Kushen Injection of the present application includes a performing detection by using high-performance liquid chromatography-evaporative light scattering detection method, in which the conditions for high-performance liquid chromatography evaporative light scattering are:

| Chromatographic | Prevail Carbo-hydrate ES column, 4. 6 mm × 250 | | |
|---|---|---|---|
| column | mm, 5 μm | | |
| Mobile phase | Acetonitrile-water gradient elution | | |
| | | Acetonitrile | |
| | Time (min) | (%) | Water (%) |
| Elution conditions | 0-25 | 85 | 15 |
| | 25-30 | 85-70 | 15-30 |
| | 30-45 | 70 | 30 |

| | |
|---|---|
| Column temperature | 15° C. |
| Flow rate | 1 ml/min |
| Detector | Evaporative light scattering detector (ELSD) |
| Evaporating | 60° C. |
| temperature | |
| Atomizing | 60° C. |
| temperature | |
| Flow rate of carrier | 1.5 L/min |
| gas (N₂) | |

(1) Preparation of blank solution: preparing acetonitrile-water=50:50 mixed solution;
(2) Preparation of reference substance solution: accurately weighing an appropriate amount of D-fructose reference substance, pinitol reference substance, D-glucose anhydrous reference substance, and sucrose reference substance, adding the blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking, which is obtained; and preparing two copies using the same method;
(3) Preparation of test substance solution: accurately weighing 1 ml of Compound Kushen Injection, adding to a 20 ml volumetric flask, adding the blank solution to scale, shaking, filtering, and taking a subsequent filtrate as the test substance solution;
(4) Detection: injecting samples in the order of blank solution, reference substance solution, and test substance solution, and then using the external standard two point method to calculate the content of D-fructose, pinitol, D-glucose anhydrous, and sucrose in the test substance.

In the method according to the present application, as one of the embodiments, a fingerprint method for detecting Compound Kushen Injection includes: constructing a fingerprint of Compound Kushen Injection containing D-glucose anhydrous, D-fructose, sucrose, and pinitol.

In the method according to the present application, as one of the embodiments, the method comprises: the method includes performing detection by using a high performance liquid chromatography evaporative light scattering method, wherein the conditions for high performance liquid chromatography evaporative light scattering include:

| Chromatographic | Prevail Carbo-hydrate ES column, 4. 6 mm × 250 | | |
|---|---|---|---|
| column | mm, 5 μm | | |
| Mobile phase | Acetonitrile-water gradient elution | | |
| | | Acetonitrile | |
| | Time (min) | (%) | Water (%) |
| Elution conditions | 0-25 | 85 | 15 |
| | 25-30 | 85-70 | 15-30 |
| | 30-45 | 70 | 30 |

| | |
|---|---|
| Column temperature | 15° C. |
| Flow rate | 1 ml/min |
| Detector | Evaporative light scattering detector (ELSD) |
| Evaporating | 60° C. |
| temperature | |
| Atomizing | 60° C. |
| temperature | |
| Flow rate of carrier | 1.5 L/min |
| gas (N₂) | |

(1) Preparation of blank solution: preparing acetonitrile and water=50:50 mixed solution;
(2) Preparation of reference substance solution: accurately weighing an appropriate amount of D-fructose reference substance, pinitol reference substance, D-glucose anhydrous reference substance, and sucrose reference substance, adding the blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking, which is obtained; and preparing two copies using the same method;
(3) Preparation of test substance solution: accurately weighing 1 ml of Compound Kushen Injection, adding to a 20 ml volumetric flask, adding the blank solution to scale, shaking, filtering, and taking a subsequent filtrate as the test substance solution;
(4) Construction of standard fingerprint spectrum: injecting samples in the order of blank solution, reference substance solution, and test substance solution to construct a standard fingerprint spectrum of Compound Kushen Injection containing D-glucose anhydrous, D-fructose, sucrose, and pinitol;
(5) Detection: injecting samples in the order of blank solution, reference substance solution, and test substance solution, and then use the external standard two point method to calculate the content of D-fructose, pinitol, D-glucose anhydrous, and sucrose in the test substance.

In the method according to the present application, as one of the embodiments, the sample can be injected as follows:

| Sequence | Samples | Injections |
|---|---|---|
| 1 | Blank solution | 1 injection |
| 2 | Reference substance | 5 injections (continuous |
| | solution | injections) |
| 3 | Test substance solution | 1 injection |

In the method according to the present application, as one of the embodiments, the standard fingerprint spectrum includes three unknown peaks, D-fructose chromatographic peak, pinitol chromatographic peak, D-glucose anhydrous chromatographic peak, and sucrose chromatographic peak.

In the method according to the present application, as one of the embodiments, the relative retention times of the three unknown peaks in the standard fingerprint spectrum are 0.100-0.130, preferably 0.12; 0.135-0.150, preferably 0.14; 0.170-0.190, preferably 0.18; the relative retention time of D-fructose is 0.660-0.690, preferably 0.67; the relative retention time of pinitol is 0.695-0.730, preferably 0.70; the relative retention time of D-glucose anhydrous is 1.00; and the relative retention time of sucrose is 1.130-1.153, preferably 1.14.

In the method according to the present application, as one of the embodiments, the relative peak areas of the three unknown peaks in the standard fingerprint are 0.32, 0.03, and 2.36, respectively; the relative peak area of D-fructose is 2.32; the relative peak area of pinitol is 0.10; the relative peak area of D-glucose anhydrous is 1.00; and the relative peak area of sucrose is 0.19.

The most advantage of the method according to the present application over general methods is that it can simultaneously detect D-fructose and pinitol. Under general chromatographic conditions, in the presence of D-fructose and pinitol simultaneously, fructose and pinitol form one chromatographic peak, which is difficult to separate. The method according to the present application solves this problem and simultaneously determines the content of four saccharides and establishes a saccharides fingerprint.

Compared to the existing detection methods for Compound Kushen Injection, the present application adopts a high-performance liquid chromatography-evaporative light scattering detection method (HPLC-ELSD method), which can simultaneously determine four sugar components in Compound Kushen Injection, and construct a chromatographic fingerprint using this method, providing a fast and efficient technical method for quality control in Compound Kushen Injection, while reducing the workload of testing.

### BRIEF DESCRIPTION OF THE DRAWINGS

FIG. 1 shows the results of blank and negative samples in Example 1.

FIG. 2 shows the linear diagram of D-fructose, pinitol, D-glucose anhydrous, and sucrose indicators in Example 1.

FIG. 3 shows the fingerprint of a standard reference substance in Example 2.

FIG. 4 shows the superimposed fingerprint of investigating different batches of test substances in Example 2.

FIG. 5 shows repetitive superimposed fingerprint of investigating different batches of test substances in Example 2.

FIG. 6 shows a stable fingerprint in Example 2.

FIG. 7 shows a double time fingerprint in Example 2.

FIGS. 8-1 to 8-3 show the results of the investigation of different chromatographic columns in Example 3.

FIGS. 9-1 to 9-4 show the results of investigating different mobile phase gradients in Example 3.

FIGS. 10-1 to 10-5 show the results of investigating different column temperature in Example 3.

FIGS. 11-1 to 11-3 show the results of investigating different flow rates in Example 3.

FIGS. 12-1 to 12-3 show the results of the investigation of different evaporation temperatures in Example 3.

FIGS. 13-1 to 13-3 show the results of investigating different atomization temperatures in Example 3.

FIGS. 14-1 to 14-3 show the results of investigating different flow rate of carrier gas in Example 3.

### DETAILED DESCRIPTION

The following embodiments and experimental examples are used to further elaborate on the present application, but do not in any way limit the effective scope of the present application.

Instruments

| Name of | | |
|---|---|---|
| instruments | Models | Manufacturer |
| Liquid | Agilent 1260 ELSD | Agilent Technology |
| chromatograph | | Co., Ltd |
| Electric | XSE205DU | METTLER TOLEDO |
| scale | ME 204 | METTLER TOLEDO |
| CNC ultrasonic | KQ5200DE | Kunshan Ultrasonic |
| cleaner | | Instrument Co., Ltd |
| Chromatographic | Prevail Carbo-hydrate ES | US ALLTECH |
| column | column 4. 6 mm × 250 | SCIENTIFIC LIMITED |
| | mm, 5 μm Sel No. | |
| | J2910088 | |

Reference substance

| No. | Reference source | Name | Structure | CAS No. |
|---|---|---|---|---|
| 1 | National Institutes for Food and Drug Control | D-fructose | 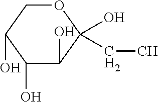 | 57-48-7 |
| 2 | Chengdu Herbpurify Co. Ltd. | Pinitol | 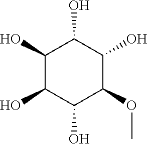 | 10284-63-6 |
| 3 | National Institutes for Food and Drug Control | D-Glucose anhydrous | 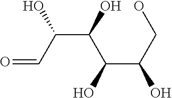 [SMILES: O=C[C@H](O)[C@@H](O)[C@H](O)[C@H](O)CO] | 50-99-7 |
| 4 | National Institutes for Food and Drug Control | Sucrose | 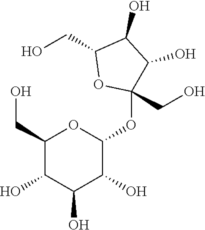 [SMILES: OC[C@H]1O[C@@](CO)(O[C@H]2O[C@H](CO)[C@@H](O)[C@H](O)[C@H]2O)[C@@H](O)[C@@H]1O] | 57-50-1 |

Reagent

| Name | Batch No. | Source | Grade |
|---|---|---|---|
| Methanol | 10984507849 | Merck KGaA | HPLC |
| Acetonitrile | SHBK9452 | Merck KGaA | HPLC |

Test substance

| Name | Batch No. | Source |
|---|---|---|
| Compound Kushen Injection | 20181034 | Shanxi Zhendong Pharmaceutical Co., Ltd |
| Compound Kushen Injection | 20181138 | Shanxi Zhendong Pharmaceutical Co., Ltd |
| Compound Kushen Injection | 20181139 | Shanxi Zhendong Pharmaceutical Co., Ltd |
| Compound Kushen Injection | 20181203 | Shanxi Zhendong Pharmaceutical Co., Ltd |
| Compound Kushen Injection | 20181204 | Shanxi Zhendong Pharmaceutical Co., Ltd |
| Compound Kushen Injection | 20181209 | Shanxi Zhendong Pharmaceutical Co., Ltd |
| Compound Kushen Injection | 20181212 | Shanxi Zhendong Pharmaceutical Co., Ltd |
| Compound Kushen Injection | 20181213 | Shanxi Zhendong Pharmaceutical Co., Ltd |
| Compound Kushen Injection | 20181214 | Shanxi Zhendong Pharmaceutical Co., Ltd |
| Compound Kushen Injection | 20181215 | Shanxi Zhendong Pharmaceutical Co., Ltd |
| Compound Kushen Injection | 20171102 | Shanxi Zhendong Pharmaceutical Co., Ltd |
| Compound Kushen Injection | 20180101 | Shanxi Zhendong Pharmaceutical Co., Ltd |
| Compound Kushen Injection | 20180301 | Shanxi Zhendong Pharmaceutical Co., Ltd |
| Compound Kushen Injection | 20190404 | Shanxi Zhendong Pharmaceutical Co., Ltd |
| Compound Kushen Injection | 20190405 | Shanxi Zhendong Pharmaceutical Co., Ltd |
| Compound Kushen Injection | 20190406 | Shanxi Zhendong Pharmaceutical Co., Ltd |
| Compound Kushen Injection | 20190407 | Shanxi Zhendong Pharmaceutical Co., Ltd |
| Compound Kushen Injection | 20190408 | Shanxi Zhendong Pharmaceutical Co., Ltd |
| Compound Kushen Injection | 20190409 | Shanxi Zhendong Pharmaceutical Co., Ltd |
| Compound Kushen Injection | 20190410 | Shanxi Zhendong Pharmaceutical Co., Ltd |
| Compound Kushen Injection | 20190412 | Shanxi Zhendong Pharmaceutical Co., Ltd |
| Compound Kushen Injection | 20190413 | Shanxi Zhendong Pharmaceutical Co., Ltd |
| Compound Kushen Injection | 20190414 | Shanxi Zhendong Pharmaceutical Co., Ltd |

### Example 1: Method for Detecting Content of Monooligosaccharides in Compound Kushen Injection

### 1. Chromatographic Conditions, Sample Preparation, System Suitability Requirements, Calculation Formulas, and Limit Requirements

| Detection method | Conditions for detection | | |
|---|---|---|---|
| Chromatographic | Prevail Carbo-hydrate ES column, 4. | | |
| column | 6 mm × 250 mm, 5 μm | | |
| Mobile phase | Acetonitrile-water gradient elution | | |
| Elution | Time | Acetonitrile | Water |
| conditions | (min) | (%) | (%) |
| | 0-25 | 85 | 15 |
| | 25-30 | 85-70 | 15□30 |
| | 30-45 | 70 | 30 |

| | |
|---|---|
| Column | 15° C. |
| temperature | |
| Flow rate | 1 ml/min |
| Detector | Evaporative light scattering detector (ELSD) |
| Evaporating | 60° C. |
| temperature | |
| Atomizing | 60° C. |
| temperature | |
| Flow rate of | 1.5 L/min |
| carrier gas (N₂) | |
| Injection amount | 10 μl |
| Solvent | Acetonitrile-water (50:50) mixed solution |
| Test substance | Accurately weighing 1 ml of Compound Kushen |
| solution | Injection, adding to a 20 ml volumetric flask, |
| | adding a blank solution (acetonitrile-water = |
| | 50:50) to scale, shaking, filtering, and |
| | taking the subsequent filtrate as the test |
| | substance solution |
| Reference | Reference substance solution: accurately |
| substance | weighing an appropriate amount of D-fructose |
| solution | reference substance, pinitol reference |
| | substance, D-glucose anhydrous reference |
| | substance, and sucrose reference substance, |
| | adding a blank solution to prepare a mixed |
| | reference solution containing 1.008 mg of |
| | D-fructose, 0.195 mg of pinitol, 0.90 mg |
| | of D-glucose anhydrous, and 0.20 mg of |
| | sucrose per 1 ml; and shaking, which is |
| | obtained |
| System | Mixed reference substance solution |
| adaptability | |
| solution | |
| System | Continuously testing the reference |
| adaptability | substance solution 5 times, with a peak |
| requirements | area RSD of no more than 5.0%, a retention |
| | time RSD of no more than 2.0%, a |
| | theoretical plate number of no less than |
| | 5000 for the main peak, a trailing factor |
| | of no more than 1.3, and a resolution |
| | greater than 1.5 |
| Calculation | two-point external standard method |
| method | |

### 2. Specific Verification Content

2.1 System Adaptability

(1) Experimental Steps

Preparation of blank solution: preparing acetonitrile and water=50:50 mixed solution, and filtering, which is obtained.

Preparation of reference substance solution: accurately weighing an appropriate amount of D-fructose reference substance, pinitol reference substance, D-glucose anhydrous reference substance, and sucrose reference substance, adding a blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking.

Preparation of test substance solution: accurately weighing 1 ml of Compound Kushen Injection, adding to a 20 ml volumetric flask, adding the blank solution to scale, shaking, filtering, and taking a subsequent filtrate as the test substance solution.

Injection sequence

| Sequence | Samples | Injections |
|---|---|---|
| 1 | Blank solution | 1 injection |
| 2 | Reference substance | 5 injections |
| | solution | (continuous |
| | | injections) |
| 3 | Test substance solution | 1 injection |

(2) Result Report

RSD values of peak area and retention time for continuous 5 injections of the reference substance solution.

TABLE 2.1-1
Peak area and retention time results of reference substance solution

| | D-fructose | | Pinitol | | D-Glucose anhydrous | | Sucrose | |
|---|---|---|---|---|---|---|---|---|
| Reference | Retention | | Retention | | Retention | | Retention | |
| substance | time | Peak area | time | Peak area | time | Peak area | time | Peak area |
| 1 | 23.22 | 2247824 | 24.75 | 217907 | 33.56 | 1401594 | 38.11 | 110391 |
| 2 | 23.21 | 2197437 | 24.73 | 215175 | 33.58 | 1382142 | 38.12 | 107975 |
| 3 | 23.22 | 2211851 | 24.67 | 216969 | 33.59 | 1403384 | 38.13 | 106334 |
| 4 | 23.13 | 2209039 | 24.70 | 218484 | 33.54 | 1406108 | 38.18 | 110806 |
| 5 | 23.19 | 2248911 | 24.72 | 220149 | 33.62 | 1398722 | 38.21 | 108975 |
| RSD % | 0.16 | 1.07 | 0.12 | 0.85 | 0.09 | 0.68 | 0.11 | 1.67 |

TABLE 2.1-2
System adaptability Results

| | D-fructose | | Pinitol | | | D-Glucose anhydrous | | | Sucrose | | |
|---|---|---|---|---|---|---|---|---|---|---|---|
| Reference | Plate | Trailing | Plate | Separation | Trailing | Plate | Separation | Trailing | Plate | Separation | Trailing |
| substance | number | factor | number | degreen | factor | number | degreen | factor | number | degreen | factor |
| 1 | 18964 | 1.12 | 22786 | 2.36 | 0.98 | 93504 | 16.34 | 0.95 | 234900 | 12.19 | 1.01 |
| 2 | 18954 | 1.14 | 23623 | 2.32 | 1.03 | 86833 | 16.24 | 0.95 | 235869 | 12.19 | 1.01 |
| 3 | 18221 | 1.13 | 24044 | 2.39 | 1.00 | 94256 | 16.31 | 0.92 | 232412 | 11.96 | 1.01 |
| 4 | 20387 | 1.16 | 25079 | 2.33 | 1.01 | 90757 | 16.76 | 0.96 | 229666 | 11.91 | 0.99 |
| 5 | 19783 | 1.14 | 23948 | 2.29 | 1.00 | 99150 | 16.42 | 0.95 | 238438 | 12.23 | 0.98 |

(3) Conclusion

From the results, it can be seen that the peak areas of the reference substance solution for continuous 5 injections are 0.15%, 0.12%, 0.09%, and 0.11% for D-fructose, pinitol, D-glucose anhydrous, and sucrose retention times, respectively, which are less than 1.3%. The peak area RSDs are 1.1%, 0.8%, 0.7%, and 1.7%, which are all less than 5.0%. The theoretical plate numbers of the content determination indicators are all greater than 5000, and the tailing factors are all less than 1.3%, meeting the requirements.

2.2 Specificity

(1) Experimental Steps

Preparation of blank solution: preparing acetonitrile and water=50:50 mixed solution, and filtering.

Preparation of 0.25% Tween 80 solution: weighing 0.25 g of Tween 80, dissolving in water to 100 ml, shaking, filtering, and taking the remaining filtrate as the 0.25% Tween-80 solution.

Preparation of reference substance solution: referring to Section 2.1 for the preparation method of reference substance solution.

Preparation of test substance solution: accurately weighing 1 ml of Compound Kushen Injection, adding to a 20 ml volumetric flask, adding the blank solution to scale, and shaking for use.

Preparation of filter membrane interference sample: taking the test substance solution, centrifuging one portion; filtering one portion and discarding different volumes (1 ml, 3 ml, 5 ml, 7 ml, 9 ml).

Requirements for Injection Procedure

Injection sequence

| Sequence | Samples | Injections |
|---|---|---|
| 1 | Blank solution | 1 injection |
| 2 | 0.25% Tween-80 solution | 1 injection |
| 3 | Reference substance solution | 1 injection |
| 4 | Test substance solution-centrifuging | 1 injection |
| 5 | Test substance solution-filtering 1 ml | 1 injection |
| 6 | Test substance solution-filtering 3 ml | 1 injection |
| 7 | Test substance solution-filtering 5 ml | 1 injection |
| 8 | Test substance solution-filtering 7 ml | 1 injection |
| 9 | Test substance solution-filtering 9 ml | 1 injection |

(2) Result Report

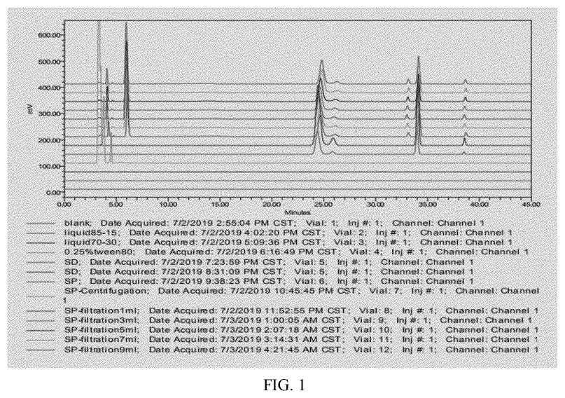

Refer to FIG. 1; FIG. 1 shows the results of blank and negative samples

TABLE 2.2-1
Results of filter membrane interference experiment (area percentage
of different discarded volumes relative to the centrifuged sample)

| | | | D-Glucose | |
|---|---|---|---|---|
| / | D-fructose % | Pinitol % | anhydrous % | Sucrose % |
| 1 ml | 103.04 | 90.63 | 101.10 | 99.11 |
| 3 ml | 105.20 | 84.02 | 101.17 | 99.50 |
| 5 ml | 104.66 | 93.00 | 100.79 | 98.59 |
| 7 ml | 104.81 | 95.96 | 102.21 | 99.90 |
| 9 ml | 106.98 | 97.21 | 101.97 | 102.40 |

(3) Conclusion

From the results, it can be seen that the blank solution, blank mobile phase, and 0.25% Tween 80 solution do not interfere with the sample. The relative content of the percentage between the area of the indicator components of the test substance solution and the area of the indicator components of the directly injected test substance solution after discarding different volumes ranges from 84.02% to 106.98%, indicating that the filter membrane has an interfering effect on the test substance and will no longer undergo filtration treatment. (Refer to FIG. 1)

2.3 Linearity and Range

(1) Experimental Steps

Preparation of blank solution: preparing acetonitrile and water=50:50 mixed solution.

Linear storage solution: accurately weighing an appropriate amount of D-fructose reference substance, pinitol reference substance, D-glucose anhydrous reference substance, and sucrose reference substance, adding a blank solution to prepare a mixed reference substance solution containing 2.02 mg of D-fructose, 0.39 mg of pinitol, 1.80 mg of D-glucose anhydrous, and 0.40 mg of sucrose per 1 ml, and shaking, which is obtained.

33% reference substance solution: accurately weighing 1.5 ml of the mixed reference substance solution, adding to a 10 ml volumetric flask, diluting with blank solution to scale, and shaking, which is obtained.

40% reference substance solution: accurately weighing 2 ml of the mixed reference substance solution, adding to a 10 ml volumetric flask, diluting with blank solution to scale, and shaking, which is obtained.

60% reference substance solution: accurately weighing 3 ml of the mixed reference substance solution, adding to a 10 ml volumetric flask, diluting with blank solution to scale, and shaking, which is obtained.

80% reference substance solution: accurately weighing 4 ml of the mixed reference substance solution, adding to a 10 ml volumetric flask, diluting with blank solution to scale, and shaking, which is obtained.

100% reference substance solution: accurately weighing 5 ml of the mixed reference substance solution, adding to a 10 ml volumetric flask, diluting with blank solution to scale, and shaking, which is obtained.

140% reference substance solution: accurately weighing 3.5 ml of the mixed reference substance solution, adding to a 5 ml volumetric flask, diluting with blank solution to scale, and shaking.

Requirements for Injection Procedure

Injection sequence

| Sequence | Samples | Injections |
|---|---|---|
| 1 | Blank solution | 1 injection |
| 2 | Reference substance | Continuous |
| | solution | 5 injections |
| 3 | 33% linear solution | 1 injection |
| 4 | 40% linear solution | 1 injection |
| 5 | 60% linear solution | 1 injection |
| 6 | 80% linear solution | 1 injection |
| 7 | 100% linear solution | 1 injection |
| 8 | 140% linear solution | 1 injection |
| 9 | Reference substance | 1 injection |
| | solution | |

(2) Result Report

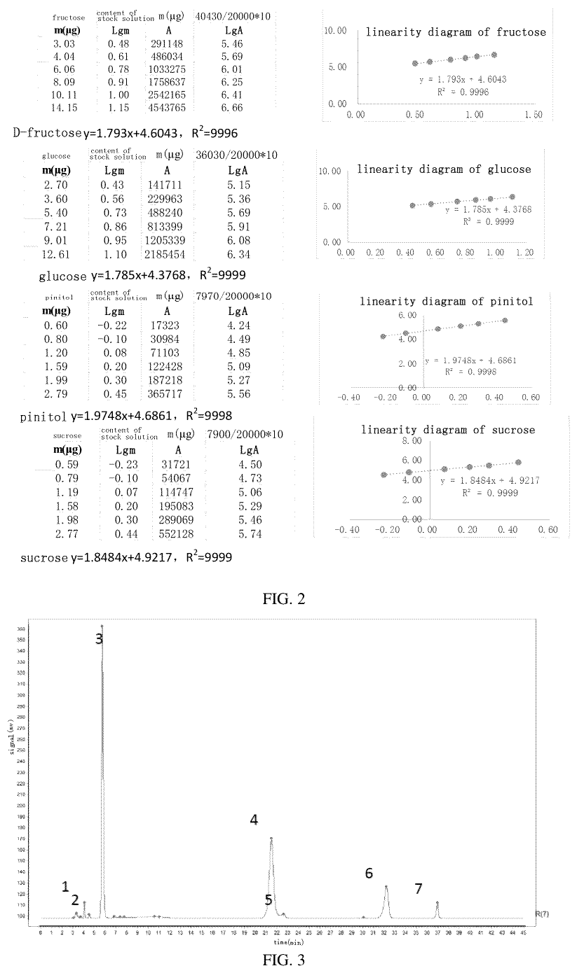

The regression equation, correlation coefficient, and linear graph results of individual indicator components are as follows (plotted with the reciprocal of mass and peak area) (see FIG. 2 for details, which shows the linear graph of D-fructose, pinitol, D-glucose anhydrous, and sucrose indicator components)

(3) Conclusion

The linear correlation coefficient should be ≥0.999, which meets the standard.

2.4 Sensitivity

(1) Experimental Steps

Preparation of blank solution: preparing acetonitrile and water=50:50 mixed solution.

Preparation of reference substance solution: referring to Section 2.1 for the preparation method of reference substance solution.

Quantitative limit and detection limit solution: the reference substance solution is diluted step by step with a blank solution. When the signal-to-noise ratio (S/N) of pinitol is 10:1, it is used as the quantitative limit solution. When the signal-to-noise ratio (S/N) of pinitol is 2-3, it is used as the detection limit solution.

Requirements for Injection Procedure

Injection sequence

| Sequence | Samples | Injections |
|---|---|---|
| 1 | Blank solution | 1 injection |
| 2 | Reference substance 1 solution | 5 injections |
| | | (continuous tests) |
| 3 | Quantitative limit solution | 6 injections |
| 4 | Detection limit solution | 2 injections |

(3) Result Report

TABLE 2.4-1
Statistics of quantitative limit results

| | | | | | | | | RSD |
|---|---|---|---|---|---|---|---|---|
| | 1 | 2 | 3 | 4 | 5 | 6 | Average | (%) |
| Pinitol Peak | 11907 | 11998 | 11542 | 11337 | 10572 | 11062 | 11403 | 4.29 |
| Retention | 26.096 | 26.245 | 26.291 | 26.291 | 26.072 | 26.11 | 26.18 | 0.36 |
| time (min) | | | | | | | | |

TABLE 2.4-2
sensitivity test results

| Item | |
|---|---|
| Quantitative limit | Detection limit |

| | Percentage (%) | unit | Percentage (%) | unit |
|---|---|---|---|---|
| | relative to test | in ng | relative to test | in ng |
| Name | substance | (ng) | substance | (ng) |
| Pinitol | 1 | 404 | 0.75 | 303 |

(3) Conclusion

From the results, it can be seen that, after continuous injection of the quantitative limit solution, the RSD value of the retention time of the pinitol peak is less than 1.3%, and the peak area is less than 5.0%; the quantitative limit of pinitol is 404 ng, and the detection limit is 303 ng.

2.5 Repeatability

(1) Experimental Steps

Preparation of blank solution: preparing acetonitrile and water=50:50 mixed solution.

Preparation of reference substance solution: referring to Section 2.1 for the preparation method of reference substance solution to prepare two copies using the same method.

Preparation of test substance solution (6 parts): accurately weighing 1 ml of Compound Kushen Injection, adding to a 20 ml volumetric flask, adding the blank solution to scale, shaking, and using it as the test substance solution; and performing 6 copies operations in parallel.

Requirements for Injection Procedure

Injection sequence

| Sequence | Samples | Injections |
|---|---|---|
| 1 | Blank solution | 1 injection |
| 2 | Reference substance1 solution | 5 injections |
| | | (continuous tests) |
| 3 | Reference substance2 solution | 2 injections |
| 4 | Reference substance2 solution | 2 injections |
| | (20 μl) | |
| 5 | Test substance-1 solution | 1 injection |
| 6 | Test substance-2 solution | 1 injection |
| 7 | Test substance-3 solution | 1 injection |
| 8 | Test substance-4 solution | 1 injection |
| 9 | Test substance-5 solution | 1 injection |
| 10 | Test substance-6 solution | 1 injection |
| 11 | Reference substancel solution | 1 injection |

(2) Result Report

TABLE 2.5
Repeatability test results

| | | | | | | | Average | RSD % |
|---|---|---|---|---|---|---|---|---|
| / | 1 | 2 | 3 | 4 | 5 | 6 | (%) | (%) |
| D-fructose | 20.952 | 21.249 | 21.066 | 20.949 | 20.877 | 20.825 | 20.986 | 0.73 |
| Pinitol | 3.206 | 3.219 | 3.223 | 3.192 | 3.173 | 3.139 | 3.192 | 0.99 |
| D-Glucose anhydrous | 18.534 | 18.311 | 18.201 | 18.336 | 18.473 | 18.467 | 18.387 | 0.68 |
| Sucrose | 3.253 | 3.272 | 3.257 | 3.282 | 3.247 | 3.257 | 3.261 | 0.40 |

(3) Conclusion

The RSD of D-fructose, pinitol, D-glucose anhydrous, and sucrose content in the 6 test substances is not greater than 5.0%, indicating good repeatability of the test substances.

2.6 Solution Stability

(1) Experimental Steps

Preparation of blank solution: preparing acetonitrile and water=50:50 mixed solution.

Preparation of reference substance solution: referring to Section 2.1 for the preparation method of reference substance solution to prepare two copies using the same method.

Preparation of test substance solution: accurately weighing 1 ml of Compound Kushen Injection, adding to a 20 ml volumetric flask, adding the blank solution to scale, shaking, and using it as the test substance solution.

Requirements for Injection Procedure

Injection sequence

| Sequence | Samples | Injections |
|---|---|---|
| 1 | Blank solution | 1 injection |
| 2 | Reference substance1 solution | 5 injections |
| | | (continuous tests) |
| 3 | Reference substance2 solution/ | 2 injections |
| | Reference substance-0 h | |
| 4 | Reference substance2 solution | 2 injections |
| | (20 μl) | |
| 5 | Test substance-0 h | 1 injection |
| 6 | Reference substance-4 h | 1 injection |
| 7 | Test substance-4 h | 1 injection |
| 8 | Reference substance-8 h | 1 injection |
| 9 | Test substance-8 h | 1 injection |
| 10 | Reference substance-12 h | 1 injection |
| 11 | Test substance-12 h | 1 injection |
| 12 | Reference substance-16 h | 1 injection |
| 13 | Test substance-16 h | 1 injection |
| 14 | Reference substance-20 h | 1 injection |
| 15 | Test substance-20 h | 1 injection |
| 16 | Reference substance-24 h | 1 injection |
| 17 | Test substance-24 h | 1 injection |
| 18 | Reference substancel solution | 1 injection |

(2) Result Report

TABLE 2.6
Solution Stability Test Results

| | | | | | | | | Average | RSD |
|---|---|---|---|---|---|---|---|---|---|
| Time (h) | 0 | 4 | 8 | 12 | 16 | 20 | 24 | (%) | (%) |
| D-fructose content (%) | 18.90 | 18.42 | 18.10 | 18.59 | 19.01 | 19.01 | 19.30 | 18.76 | 2.20 |
| Relative 0 h content | / | 97.44 | 95.76 | 98.38 | 100.60 | 100.59 | 102.13 | / | / |
| Pinitol content (%) | 3.64 | 3.66 | 3.54 | 3.58 | 3.65 | 3.69 | 3.70 | 3.64 | 1.64 |
| Relative 0 h content | / | 100.56 | 97.10 | 98.33 | 100.33 | 101.45 | 101.59 | / | / |
| D-Glucose anhydrous | 16.10 | 16.08 | 16.15 | 16.24 | 16.39 | 16.58 | 16.79 | 16.33 | 1.64 |
| content (%) | | | | | | | | | |
| Relative 0 h content | / | 99.89 | 100.33 | 100.89 | 101.80 | 102.98 | 104.28 | / | / |
| Sucrose content (%) | | 5.77 | 5.76 | 5.70 | 5.77 | 5.83 | 5.89 | 5.81 | 1.33 |
| Relative 0 h content | / | 99.84 | 98.66 | 100.03 | 100.92 | 102.06 | 102.48 | 100.57 | / |

(3) Conclusion

The control solution and the test substance solution are placed at room temperature for 24 hours, and the RSD of D-fructose, pinitol, D-glucose anhydrous, and sucrose content in the test substance is not greater than 5.0%.

For the percentage of the area of individual indicator components at individual time points to the area of the 0-hour indicator component, the relative content of the results of the control and test substance solution at individual time points compared to the initial results is between 95.76% and 104.284% indicating good stability of the solution within 24 hours.

2.7 Accuracy

(1) Experimental Steps

Preparation of blank solution: preparing acetonitrile and water=50:50 mixed solution.

Preparation of reference substance solution: referring to Section 2.1 for the preparation method of reference substance solution to prepare 2 copies using the same method.

50% recovery solution: accurately weighing 0.5 ml of Compound Kushen Injection, adding to a 20 ml volumetric flask, adding 5 ml of the reference substance solution, adding the blank solution to scale, shaking, filtering, and using it as a 50% recovery solution (prepare 3 copies using the same method).

100% recovery solution: accurately weighing 0.5 ml of Compound Kushen Injection, adding to a 20 ml volumetric flask, adding 10 ml of the reference substance solution separately, adding the blank solution to scale, shaking, filtering, and using it as a 100% recovery solution (prepare 3 copies using the same method).

150% recovery solution: accurately weighing 0.5 ml of Compound Kushen Injection, adding to a 20 ml volumetric flask, adding 15 ml of the reference substance solution, adding the blank solution to scale, shaking, filtering, and using it as a 150% recovery solution (prepare 3 copies using the same method).

Requirements for Injection Procedure

Injection sequence

| Sequence | Samples | Injections |
|---|---|---|
| 1 | Blank solution | 1 injection |
| 2 | Reference substance1 solution | 5 injections |
| | | (continuous tests) |
| 3 | Reference substance2 solution | 2 injections |
| 4 | Reference substance2 solution | 2 injections |
| 5 | 50%-1 recovery solution | 2 injections |
| 6 | 50%-2 recovery solution | 2 injections |
| 7 | 50%-3 recovery solution | 2 injections |
| 8 | 100%-1 recovery solution | 2 injections |
| 9 | 100%-2 recovery solution | 2 injections |
| 10 | 100%-3 recovery solution | 2 injections |
| 11 | 150%-1 recovery solution | 2 injections |
| 12 | 150%-2 recovery solution | 2 injections |
| 13 | 150%-3 recovery solution | 2 injections |
| 14 | Reference substancel solution | 1 injection |

(2) Result Report

Recovery rate calculation formula: Recovery rate=(Measured value−content of test substance×sampling amount of test substance)/adding amount of reference substance×100%

TABLE 2.7-1
D-Fructose content recovery test results

| | Adding amount | | | | | |
|---|---|---|---|---|---|---|
| | of reference | Content of test | Measured | Recovery | Average/ | |
| / | substance/mg | substance/mg | value/mg/ml | rate/% | % | RSD/% |
| 50%-1 | 5.045 | 10.493 | 16.72 | 123.47 | 115.08 | 3.16 |
| 50%-2 | 5.045 | 10.493 | 16.13 | 111.78 | | |
| 50%-3 | 5.045 | 10.493 | 16.15 | 112.12 | | |
| 100%-1 | 10.09 | 10.493 | 22.19 | 115.96 | | |
| 100%-2 | 10.09 | 10.493 | 21.92 | 113.21 | | |
| 100%-3 | 10.09 | 10.493 | 22.34 | 117.45 | | |
| 150%-1 | 15.135 | 10.493 | 27.68 | 113.58 | | |
| 150%-2 | 15.135 | 10.493 | 27.91 | 115.08 | | |
| 150%-3 | 15.135 | 10.493 | 27.61 | 113.10 | | |

TABLE 2.7-2
Test results of pinitol content recovery rate

| | Adding amount | Content of | | | | |
|---|---|---|---|---|---|---|
| | of reference | test | Measured | Recovery | Average/ | RSD/ |
| / | substance/mg | substance/mg | value/mg/ml | rate/% | % | % |
| 50%-1 | 0.804 | 1.596 | 2.42 | 102.54 | 106.11 | 4.86 |
| 50%-2 | 0.804 | 1.596 | 2.38 | 98.02 | | |
| 50%-3 | 0.804 | 1.596 | 2.39 | 98.39 | | |
| 100%-1 | 1.608 | 1.596 | 3.33 | 107.54 | | |
| 100%-2 | 1.608 | 1.596 | 3.32 | 107.25 | | |
| 100%-3 | 1.608 | 1.596 | 3.37 | 110.18 | | |
| 150%-1 | 2.412 | 1.596 | 4.25 | 109.92 | | |
| 150%-2 | 2.412 | 1.596 | 4.27 | 111.01 | | |
| 150%-3 | 2.412 | 1.596 | 4.25 | 110.14 | | |

TABLE 2.7-3
D-glucose anhydrous content recovery test results

| | Adding amount | Content of | | | | |
|---|---|---|---|---|---|---|
| | of reference | test | Measured | Recovery | Average/ | RSD/ |
| / | substance/mg | substance/mg | value/mg/ml | rate/% | % | % |
| 50%-1 | 4.498 | 9.1935 | 14.36 | 114.83 | 110.94 | 3.08 |
| 50%-2 | 4.498 | 9.1935 | 13.97 | 106.18 | | |
| 50%-3 | 4.498 | 9.1935 | 13.96 | 105.98 | | |
| 100%-1 | 8.996 | 9.1935 | 19.05 | 109.60 | | |
| 100%-2 | 8.996 | 9.1935 | 18.97 | 108.71 | | |
| 100%-3 | 8.996 | 9.1935 | 19.42 | 113.62 | | |
| 150%-1 | 13.494 | 9.1935 | 24.32 | 112.11 | | |
| 150%-2 | 13.494 | 9.1935 | 24.58 | 113.99 | | |
| 150%-3 | 13.494 | 9.1935 | 24.50 | 113.45 | | |

TABLE 2.7-4
Sucrose content recovery test results

| | Adding amount | Content of | | | | |
|---|---|---|---|---|---|---|
| | of reference | test | Measured | Recovery | Average/ | RSD/ |
| / | substance/mg | substance/mg | value/mg/ml | rate/% | % | % |
| 50%-1 | 0.85 | 1.6305 | 2.62 | 114.83 | 107.98 | 3.57 |
| 50%-2 | 0.85 | 1.6305 | 2.51 | 106.18 | | |
| 50%-3 | 0.85 | 1.6305 | 2.53 | 105.98 | | |
| 100%-1 | 1.70 | 1.6305 | 3.47 | 109.60 | | |
| 100%-2 | 1.70 | 1.6305 | 3.40 | 108.71 | | |
| 100%-3 | 1.70 | 1.6305 | 3.52 | 113.62 | | |
| 150%-1 | 2.55 | 1.6305 | 4.35 | 112.11 | | |
| 150%-2 | 2.55 | 1.6305 | 4.39 | 113.99 | | |
| 150%-3 | 2.55 | 1.6305 | 4.38 | 113.45 | | |

(3) Conclusion

The recovery rate of D-fructose in the test substance ranges from 111.78% to 123.47%, the recovery rate of pinitol ranges from 98.02% to 111.01%, the recovery rate of D-glucose anhydrous ranges from 105.98% to 114.83%, and the recovery rate of sucrose ranges from 105.98% to 114.83%. The RSD values of the nine copies recoveries are 3.16%, 4.86%, 3.08%, and 3.57%, all of which are less than 5.0%, meeting the requirements.

2.8 Sample Determination

(1) Experimental Steps

Preparation ofblank solution: preparing acetonitrile and water=50:50 mixed solution.

Preparation of reference substance solution: referring to Section 2.1 for the preparation method of reference substance solution to prepare two copies using the same method.

Preparation of test substance solution: accurately weighing 1 ml of investigating different batches of Compound Kushen Injection, adding to a 20 ml volumetric flask, adding the blank solution to scale, shaking, filtering, and taking a subsequent filtrate as the test substance solution.

Injection Procedure Requirements.

Injection sequence

| Sequence | Samples | Injections |
|---|---|---|
| 1 | Blank solution | 1 injection |
| 2 | Reference substance1 solution | 5 injections |
| 3 | Reference substance2 solution | 2 injections |
| 4 | Reference substance2 solution | 2 injections |
| | (20 μl) | |
| 5 | Test substance-1 | 1 injection |
| 6 | Test substance-2 | 1 injection |
| 3to22 | Test substance 3to 22 | 1 injection/each |
| | | test substance |
| 23 | Test substance-23 | 1 injection |
| 24 | Reference substancel solution | 1 injection |

(2) Result Report

TABLE 2.8
Content determination results

| Content | | | D-Glucose | |
|---|---|---|---|---|
| mg/ml | D-fructose | Pinitol | anhydrous | Sucrose |
| 20181203 | 20.55 | 2.71 | 19.07 | 3.78 |
| 20181204 | 20.22 | 2.60 | 18.77 | 3.76 |
| 20181209 | 19.22 | 2.79 | 17.98 | 2.52 |
| 20181212 | 18.26 | 2.73 | 17.68 | 2.05 |
| 20181213 | 19.59 | 2.65 | 18.19 | 2.82 |
| 20181214 | 20.29 | 2.78 | 18.52 | 2.94 |
| 20181215 | 20.23 | 2.88 | 18.48 | 4.32 |
| 20181034 | 20.65 | 2.80 | 18.37 | 3.16 |
| 20181138 | 22.70 | 2.94 | 20.98 | 2.54 |
| 20181139 | 22.81 | 3.36 | 19.46 | 3.80 |
| 20190404 | 21.76 | 1.84 | 18.33 | 3.38 |
| 20190405 | 18.66 | 1.78 | 15.04 | 5.05 |
| 20190406 | 19.18 | 1.75 | 15.27 | 5.08 |
| 20190407 | 20.55 | 1.84 | 16.45 | 4.53 |
| 20190408 | 20.83 | 1.83 | 16.67 | 4.59 |
| 20190409 | 20.88 | 1.83 | 16.67 | 4.39 |
| 20190410 | 21.17 | 1.88 | 16.69 | 4.35 |
| 20190412 | 20.59 | 1.91 | 16.99 | 2.36 |
| 20190413 | 22.58 | 1.82 | 19.04 | 1.47 |
| 20190414 | 21.83 | 1.66 | 18.78 | 1.40 |
| 20180101 | 20.39 | 2.09 | 17.10 | 5.23 |
| 20180301 | 19.31 | 2.46 | 13.70 | 5.63 |
| 20171102 | 27.43 | 3.29 | 22.96 | 1.79 |

### Example 2: Fingerprint Detection Method for Compound Kushen Injection

### 1. Chromatographic Conditions, Elution Conditions, Sample Preparation, Etc

| Detection method | Conditions for detection | | |
|---|---|---|---|
| Chromatographic | Prevail Carbo-hydrate ES column, 4. | | |
| column | 6 mm × 250 mm, 5 μm | | |
| Mobile phase | Acetonitrile-water gradient elution | | |
| Elution | Time | Acetonitrile | Water |
| conditions | (min) | (%) | (%) |
| | 0-25 | 85 | 15 |
| | 25-30 | 85-70 | 15-30 |
| | 30-45 | 70 | 30 |
| Column | 15° C. | | |
| temperature | | | |
| Flow rate | 1 ml/min | | |
| Detector | Evaporative light scattering detector (ELSD) | | |
| Evaporating | 60° C. | | |
| temperature | | | |
| Atomizing | 60° C. | | |
| temperature | | | |
| Flow rate of | 1.5 L/min | | |
| carrier gas (N2) | | | |

| | |
|---|---|
| Injection amount | 10 μl |
| Solvent | Acetonitrile-water (50:50) mixed solution |
| Test substance | Accurately weighing 1 ml of Compound Kushen Injection, |
| solution | adding to a 20 ml volumetric flask, adding a blank |
| | solution (acetonitrile-water = 50:50) to scale, |
| | shaking, filtering, and taking the subsequent filtrate |
| | as the test substance solution |
| Reference | Reference substance solution: accurately weighing an |
| substance | appropriate amount of D-fructose reference substance, |
| solution | pinitol reference substance, D-glucose anhydrous |
| | reference substance, and sucrose reference substance, |
| | adding a blank solution to prepare a mixed reference |
| | solution containing 1.008 mg of D-fructose, 0.195 mg |
| | of pinitol, 0.90 mg of D-glucose anhydrous, and 0.20 |
| | mg of sucrose per 1 ml; and shaking, which is obtained. |
| System | Mixed reference substance solution |
| adaptability | |
| solution | |
| System | Continuously testing the reference substance solution |
| adaptability | 5 times, with a peak area RSD of no more than 5.0%, a |
| requirements | retention time RSD of no more than 2.0%, a theoretical |
| | plate number of no less than 5000 for the main peak, |
| | a trailing factor of no more than 1.3, and a resolution |
| | greater than 1.5 |
| Calculation | two-point external standard method |
| method | |

2. Verification content

2.1 System Adaptability

(1) Experimental Steps

Preparation of blank solution: preparing acetonitrile and water=50:50 mixed solution, and filtering.

Preparation of reference substance solution: accurately weighing an appropriate amount of D-fructose reference substance, pinitol reference substance, D-glucose anhydrous reference substance, and sucrose reference substance, adding a blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking, which is obtained.

Preparation of test substance solution: accurately weighing 1 ml of Compound Kushen Injection, adding to a 20 ml volumetric flask, adding the blank solution to scale, shaking, and using it as the test substance solution.

The injection sequence and requirements are shown in the table below.

Injection sequence

| Sequence | Samples | Injections |
|---|---|---|
| 1 | Blank solution | 1 injection |
| 2 | Reference substance solution | 5 injections |
| | | (continuous |
| | | injections) |
| 3 | Test substance solution | 1 injection |
| 4 | Reference substance solution | 1 injection |

(2) Result Report

RSD values of peak area and retention time for 5 continuous injections of the reference substance solution.

TABLE 2.1-1
Peak area and retention time results of reference substance solution

| | D-fructose | | Pinitol | | D-Glucose anhydrous | | Sucrose | |
|---|---|---|---|---|---|---|---|---|
| Reference | Retention | Peak | Retention | Peak | Retention | Peak | Retention | Peak |
| substance | time | area | time | area | time | area | time | area |
| 1 | 23.22 | 2247824 | 24.75 | 217907 | 33.56 | 1401594 | 38.11 | 110391 |
| 2 | 23.21 | 2197437 | 24.73 | 215175 | 33.58 | 1382142 | 38.12 | 107975 |
| 3 | 23.22 | 2211851 | 24.67 | 216969 | 33.59 | 1403384 | 38.13 | 106334 |
| 4 | 23.13 | 2209039 | 24.70 | 218484 | 33.54 | 1406108 | 38.18 | 110806 |
| 5 | 23.19 | 2248911 | 24.72 | 220149 | 33.62 | 1398722 | 38.21 | 108975 |
| RSD % | 0.16 | 1.07 | 0.12 | 0.85 | 0.09 | 0.68 | 0.11 | 1.67 |

TABLE 2.1-2
System adaptability results

| | D-fructose | | Pinitol | | | D-Glucose anhydrous | | | Sucrose | | |
|---|---|---|---|---|---|---|---|---|---|---|---|
| Reference | Plate | Trailing | Plate | Separation | Trailing | Plate | Separation | Trailing | Plate | Separation | Trailing |
| substance | number | factor | number | degreen | factor | number | degreen | factor | number | degreen | factor |
| 1 | 18964 | 1.12 | 22786 | 2.36 | 0.98 | 93504 | 16.34 | 0.95 | 234900 | 12.19 | 1.01 |
| 2 | 18954 | 1.14 | 23623 | 2.32 | 1.03 | 86833 | 16.24 | 0.95 | 235869 | 12.19 | 1.01 |
| 3 | 18221 | 1.13 | 24044 | 2.39 | 1.00 | 94256 | 16.31 | 0.92 | 232412 | 11.96 | 1.01 |
| 4 | 20387 | 1.16 | 25079 | 2.33 | 1.01 | 90757 | 16.76 | 0.96 | 229666 | 11.91 | 0.99 |
| 5 | 19783 | 1.14 | 23948 | 2.29 | 1.00 | 99150 | 16.42 | 0.95 | 238438 | 12.23 | 0.98 |

(3) Conclusion

From the results, it can be seen that the peak areas of the reference substance solution for 5 continuous injections are 0.15%, 0.12%, 0.09%, and 0.11% for D-fructose, pinitol, D-glucose anhydrous, and sucrose retention times, respectively, which are less than 1.3%. The peak area RSDs are 1.1%, 0.8%, 0.7%, and 1.7%, which are all less than 5.0%. The theoretical plate numbers of the content determination indicators are all greater than 5000, and the tailing factors are all less than 1.3%, meeting the requirements.

2.2 Establishment of Fingerprint

(1) Experimental Steps

Preparation of blank solution: preparing acetonitrile and water=50:50 mixed solution, and filtering.

Preparation of reference substance solution: referring to Section 2.1 for the preparation method of reference substance solution.

test substance solution for individual batches: accurately weighing 1 ml of Compound Kushen Injection from individual batches, adding to a 20 ml volumetric flask, adding the blank solution to scale, shaking, and using it as the test substance solution.

The injection sequence and requirements are shown in the table below.

Injection sequence

| Sequence | Samples | Injections |
|---|---|---|
| 1 | Blank solution | 1 injection |
| 2 | Reference substance solution | 5 injections (continuous |
| | | tests) |
| 3 | Test substance-1 solution | 1 injection |
| 4 | Test substance-2 solution | 1 injection |
| 5 | Test substance-3 solution | 1 injection |
| 6to 21 | Test substance 4to 19 solutions | 1 injection/each test |
| | | substance |
| 22 | Test substance-20 solution | 1 injection |
| 23 | Reference substance solution | 1 injection |

(2) Result Report

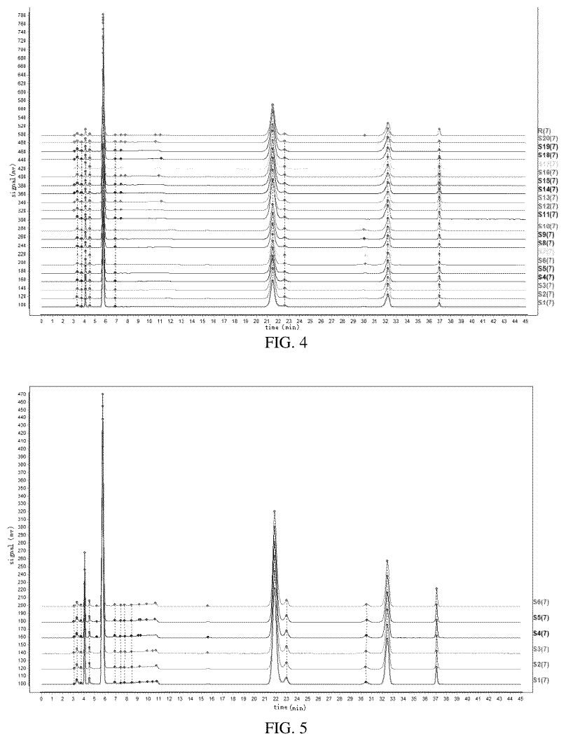

Based on the chromatographic fingerprints of 20 batches of Compound Kushen Injection, data processing is carried out using the “Similarity Evaluation System for Traditional Chinese Medicine Chromatographic Fingerprints” (2012 edition) recommended by the Pharmacopoeia Committee. The chromatographic peak of test substance 1 (20181034) is used as the reference spectrum, and the median method is used with a time window of 0.1. After multiple point correction, full peak matching is performed to generate a standard reference fingerprint and a common pattern. Please refer to FIGS. 3-4 for details.

2.2-1 Similarity results of individual batches of fingerprint spectrum and comparative fingerprints

| / | Similarity | | | | | | | | | |
|---|---|---|---|---|---|---|---|---|---|---|
| Test substance | 20181034 | 20181138 | 20181139 | 20181203 | 20181204 | 20181209 | 20181212 | 20181213 | 20181214 | 20191215 |
| 20181034 | 1.000 | 0.994 | 1.000 | 0.998 | 0.998 | 0.991 | 0.969 | 0.995 | 0.994 | 0.998 |
| 20181138 | 0.994 | 1.000 | 0.994 | 0.998 | 0.998 | 0.971 | 0.938 | 0.979 | 0.977 | 0.987 |
| 20181139 | 1.000 | 0.994 | 1.000 | 0.997 | 0.997 | 0.989 | 0.967 | 0.994 | 0.993 | 0.998 |
| 20181203 | 0.998 | 0.998 | 0.997 | 1.000 | 1.000 | 0.980 | 0.951 | 0.987 | 0.985 | 0.993 |
| 20181204 | 0.998 | 0.998 | 0.997 | 1.000 | 1.000 | 0.980 | 0.952 | 0.987 | 0.985 | 0.994 |
| 20181209 | 0.991 | 0.971 | 0.989 | 0.980 | 0.980 | 1.000 | 0.994 | 0.999 | 1.000 | 0.995 |
| 20181212 | 0.969 | 0.938 | 0.967 | 0.951 | 0.952 | 0.994 | 1.000 | 0.939 | 0.990 | 0.979 |
| 20181213 | 0.995 | 0.979 | 0.994 | 0.987 | 0.987 | 0.999 | 0.989 | 1.000 | 1.000 | 0.998 |
| 20181214 | 0.994 | 0.977 | 0.993 | 0.985 | 0.985 | 1.000 | 0.990 | 1.000 | 1.000 | 0.997 |
| 20181215 | 0.993 | 0.987 | 0.998 | 0.993 | 0.994 | 0.995 | 0.979 | 0.998 | 0.997 | 1.000 |
| 20190404 | 0.992 | 0.973 | 0.991 | 0.982 | 0.983 | 0.998 | 0.990 | 0.999 | 0.999 | 0.995 |
| 20190405 | 0.978 | 0.949 | 0.977 | 0.963 | 0.964 | 0.994 | 0.994 | 0.992 | 0.993 | 0.986 |
| 20190406 | 0.976 | 0.947 | 0.975 | 0.961 | 0.962 | 0.993 | 0.993 | 0.990 | 0.992 | 0.984 |
| 20190407 | 0.987 | 0.964 | 0.987 | 0.975 | 0.976 | 0.991 | 0.991 | 0.996 | 0.997 | 0.993 |
| 20190408 | 0.988 | 0.963 | 0.987 | 0.976 | 0.976 | 0.997 | 0.991 | 0.996 | 0.997 | 0.993 |
| 20190409 | 0.991 | 0.972 | 0.991 | 0.982 | 0.982 | 0.996 | 0.986 | 0.996 | 0.997 | 0.995 |
| 20190410 | 0.993 | 0.974 | 0.992 | 0.983 | 0.984 | 0.996 | 0.986 | 0.997 | 0.997 | 0.996 |
| 20190412 | 0.991 | 0.971 | 0.990 | 0.980 | 0.980 | 0.997 | 0.989 | 0.997 | 0.993 | 0.993 |
| 20190413 | 0.998 | 0.988 | 0.997 | 0.993 | 0.993 | 0.993 | 0.976 | 0.997 | 0.996 | 0.996 |
| 20190414 | 0.997 | 0.987 | 0.996 | 0.992 | 0.992 | 0.993 | 0.975 | 0.996 | 0.985 | 0.996 |
| R | 0.995 | 0.979 | 0.995 | 0.987 | 0.987 | 0.993 | 0.987 | 0.989 | 0.999 | 0.998 |
| / | Similarity | | | | | | | | | |
| Test substance | 20190404 | 20190405 | 20190406 | 20190407 | 20190408 | 20190409 | 20190410 | 20190412 | 20190413 | 20190414 |
| 20181034 | 0.992 | 0.978 | 0.976 | 0.987 | 0.988 | 0.991 | 0.993 | 0.991 | 0.998 | 0.997 |
| 20181138 | 0.973 | 0.949 | 0.947 | 0.964 | 0.963 | 0.972 | 0.974 | 0.971 | 0.988 | 0.987 |
| 20181139 | 0.991 | 0.977 | 0.975 | 0.987 | 0.987 | 0.991 | 0.992 | 0.990 | 0.997 | 0.996 |
| 20181203 | 0.982 | 0.963 | 0.961 | 0.976 | 0.976 | 0.982 | 0.983 | 0.980 | 0.993 | 0.992 |
| 20181204 | 0.983 | 0.964 | 0.962 | 0.976 | 0.976 | 0.982 | 0.984 | 0.980 | 0.993 | 0.992 |
| 20181209 | 0.998 | 0.994 | 0.991 | 0.997 | 0.997 | 0.996 | 0.998 | 0.997 | 0.993 | 0.993 |
| 20181212 | 0.990 | 0.994 | 0.991 | 0.991 | 0.991 | 0.986 | 0.986 | 0.989 | 0.976 | 0.975 |
| 20181213 | 0.999 | 0.992 | 0.990 | 0.996 | 0.996 | 0.996 | 0.997 | 0.997 | 0.997 | 0.996 |
| 20181214 | 0.999 | 0.993 | 0.992 | 0.997 | 0.997 | 0.997 | 0.997 | 0.998 | 0.996 | 0.995 |
| 20181215 | 0.995 | 0.986 | 0.984 | 0.993 | 0.993 | 0.995 | 0.996 | 0.993 | 0.996 | 0.996 |
| 20190404 | 1.000 | 0.995 | 0.994 | 0.999 | 0.999 | 0.998 | 0.999 | 0.999 | 0.996 | 0.995 |
| 20190405 | 0.995 | 1.000 | 0.999 | 0.998 | 0.998 | 0.993 | 0.995 | 0.994 | 0.983 | 0.982 |
| 20190406 | 0.994 | 0.999 | 1.000 | 0.997 | 0.997 | 0.995 | 0.984 | 0.994 | 0.981 | 0.981 |
| 20190407 | 0.999 | 0.998 | 0.997 | 1.000 | 1.000 | 0.998 | 0.999 | 0.997 | 0.992 | 0.991 |
| 20190408 | 0.999 | 0.998 | 0.997 | 1.000 | 1.000 | 0.998 | 0.999 | 0.997 | 0.991 | 0.991 |
| 20190409 | 0.998 | 0.995 | 0.995 | 0.993 | 0.998 | 1.000 | 0.999 | 0.999 | 0.994 | 0.993 |
| 20190410 | 0.999 | 0.993 | 0.994 | 0.999 | 0.999 | 0.999 | 1.000 | 0.998 | 0.996 | 0.995 |
| 20190412 | 0.999 | 0.994 | 0.994 | 0.997 | 0.997 | 0.999 | 0.998 | 1.000 | 0.995 | 0.994 |
| 20190413 | 0.986 | 0.983 | 0.981 | 0.992 | 0.992 | 0.994 | 0.996 | 0.995 | 1.000 | 0.999 |
| 20190414 | 0.995 | 0.982 | 0.981 | 0.991 | 0.991 | 0.993 | 0.995 | 0.994 | 0.999 | 1.000 |
| R | 1.000 | 0.993 | 0.992 | 0.996 | 0.998 | 0.999 | 0.999 | 0.998 | 0.997 | 0.997 |

TABLE 2
2-2 Results of non common peaks for individual batches

| Test | Non-common | Total peak | Percentage of non- |
|---|---|---|---|
| substance | peak area | area | commom peak area |
| 20181034 | 60091.77 | 4795683.23 | 1.25% |
| 20181138 | 63116.29 | 5147190.69 | 1.23% |
| 20181139 | 66488.50 | 5625149.45 | 1.18% |
| 20181203 | 57340.95 | 4603919.20 | 1.25% |
| 20181204 | 56063.72 | 4492491.74 | 1.25% |
| 20181209 | 98792.50 | 4928487.34 | 2.00% |
| 20181212 | 128336.95 | 5269675.50 | 2.44% |
| 20181213 | 60720.33 | 4850477.85 | 1.25% |
| 20181214 | 65671.81 | 5177579.33 | 1.27% |
| 20181215 | 107623.46 | 5063312.90 | 2.13% |
| 20190404 | 84625.12 | 8065353.75 | 1.05% |
| 20190405 | 85207.14 | 7199973.97 | 1.18% |
| 20190406 | 296286.55 | 7713478.94 | 3.84% |
| 20190407 | 97240.03 | 7714585.06 | 1.26% |
| 20190408 | 81956.49 | 7835904.60 | 1.05% |
| 20190409 | 319642.52 | 7769513.36 | 4.11% |
| 20190410 | 97023.32 | 7608901.36 | 1.28% |
| 20190412 | 305995.68 | 7557559.65 | 4.05% |
| 20190413 | 94951.65 | 7693269.20 | 1.23% |
| 20190414 | 282277.93 | 7542182.24 | 3.74% |

(3) Conclusion

Compared with the reference substance, it can be concluded that peaks 1, 2, and 3 are unknown peaks, peak 4 is D-fructose, peak 5 is pinitol, peak 6 is D-glucose anhydrous, and peak 7 is sucrose.

From the results, it can be seen that the similarity between the 20 batches of samples and the control fingerprint is greater than 0.9, and the proportion of non common peak areas is less than 5.0%.

2.3 Repeatability

(1) Experimental Steps

Preparation of blank solution: preparing acetonitrile and water=50:50 mixed solution, and filtering.

Preparation of reference substance solution: referring to Section 3.1 for the preparation method of reference substance solution.

Preparation of test substance solution: accurately weighing 1 ml of 6 copies of Compound Kushen Injection of the same batch number, adding to a 20 ml volumetric flask, adding the blank solution to scale, shaking, and using it as the test substance solution.

The injection sequence and requirements are shown in the table below.

Injection sequence

| Sequence | Samples | Injections |
|---|---|---|
| 1 | Blank solution | 1 injection |
| 2 | Reference substance solution | 5 injections (continuous tests) |
| 3 | Test substance-1 solution | 1 injection |
| 4 | Test substance-2 solution | 1 injection |
| 5 | Test substance-3 solution | 1 injection |
| 6 | Test substance-4 solution | 1 injection |
| 7 | Test substance-5 solution | 1 injection |
| 8 | Test substance-6 solution | 1 injection |
| 9 | Reference substance solution | 1 injection |

(2) Result Report

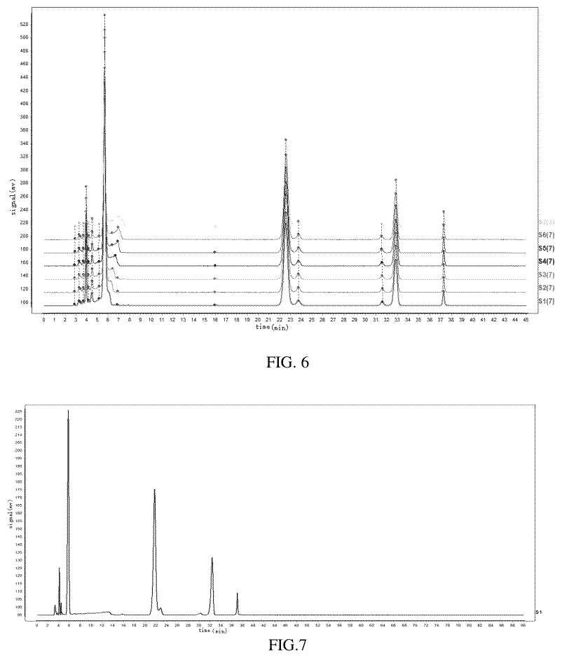

Based on the repetitive chromatogram and using the same processing method as the sample, the similarity is calculated using the “Similarity Evaluation System for Traditional Chinese Medicine Chromatographic Fingerprint”. The relative retention time and relative peak area are calculated using peak 6 (D-glucose anhydrous) as a reference. (Refer to FIG. 5)

TABLE 2.3-1
Repeatability common peak pattern similarity results

| | |
|---|---|
| / | Similarity |

| Test substance | 1 | 2 | 3 | 4 | 5 | 6 |
|---|---|---|---|---|---|---|
| 1 | 1.0 | 1.0 | 1.0 | 1.0 | 1.0 | 1.0 |
| 2 | 1.0 | 1.0 | 1.0 | 1.0 | 1.0 | 1.0 |
| 3 | 1.0 | 1.0 | 1.0 | 1.0 | 1.0 | 1.0 |
| 4 | 1.0 | 1.0 | 1.0 | 1.0 | 1.0 | 1.0 |
| 5 | 1.0 | 1.0 | 1.0 | 1.0 | 1.0 | 1.0 |
| 6 | 1.0 | 1.0 | 1.0 | 1.0 | 1.0 | 1.0 |
| R | 1.0 | 1.0 | 1.0 | 1.0 | 1.0 | 1.0 |

TABLE 2.3-2
Results of relative retention time of repetitive common peaks

| | Relative Retention time of common peak | | | | | | |
|---|---|---|---|---|---|---|---|
| / | Test | Test | Test | Test | Test | Test | RSD |
| / | substance-1 | substance-2 | substance-3 | substance-4 | substance-5 | substance-6 | (%) |
| Common peak-1 | 0.13 | 0.13 | 0.12 | 0.12 | 0.12 | 0.12 | 0.92 |
| Common peak-2 | 0.14 | 0.14 | 0.14 | 0.14 | 0.14 | 0.14 | 0.64 |
| Common peak-3 | 0.18 | 0.18 | 0.18 | 0.18 | 0.18 | 0.18 | 0.48 |
| Common peak-4 | 0.67 | 0.67 | 0.67 | 0.67 | 0.67 | 0.67 | 0.08 |
| Common peak-5 | 0.66 | 0.66 | 0.66 | 0.66 | 0.66 | 0.66 | 0.16 |
| Common peak-6 | 1.00 | 1.00 | 1.00 | 1.00 | 1.00 | 1.00 | 0.00 |
| Common peak-7 | 1.14 | 1.14 | 1.14 | 1.14 | 1.14 | 1.14 | 0.04 |

TABLE 2.3-3
Repeatability common peak relative peak area results

| | Relative peak area of Common peak | | | | | | |
|---|---|---|---|---|---|---|---|
| / | Test | Test | Test | Test | Test | Test | RSD |
| / | substance-1 | substance-2 | substance-3 | substance-4 | substance-5 | substance-6 | (%) |
| Common | 0.31 | 0.32 | 0.32 | 0.32 | 0.31 | 0.32 | 0.95 |
| peak-1 | | | | | | | |
| Common | 0.03 | 0.04 | 0.03 | 0.03 | 0.03 | 0.03 | 4.49 |
| peak-2 | | | | | | | |
| Common | 2.36 | 2.41 | 2.41 | 2.37 | 2.35 | 2.31 | 1.50 |
| peak-3 | | | | | | | |
| Common | 2.29 | 2.39 | 2.37 | 2.32 | 2.29 | 2.28 | 1.86 |
| peak-4 | | | | | | | |
| Common | 0.10 | 0.11 | 0.11 | 0.10 | 0.10 | 0.10 | 2.23 |
| peak-5 | | | | | | | |
| Common | 1.00 | 1.00 | 1.00 | 1.00 | 1.00 | 1.00 | 0.00 |
| peak-6 | | | | | | | |
| Common | 0.18 | 0.19 | 0.19 | 0.19 | 0.18 | 0.18 | 1.40 |
| peak-7 | | | | | | | |

(3) Conclusion

From the results, it can be seen that the similarity among the 6 copies test substances is greater than 0.99, and the RSD values of the relative retention time and relative peak area of each common peak are less than 5.0%, indicating good repeatability.

2.4 Solution Stability and Double Time Spectrum

(1) Experimental Steps

Preparation of blank solution: preparing acetonitrile and water=50:50 mixed solution, and filtering.

Preparation of reference substance solution: referring to Section 2.1 for the preparation method of reference substance solution.

Preparation of test substance solution: accurately weighing 1 ml of Compound Kushen Injection, adding to a 20 ml volumetric flask, adding the blank solution to scale, shaking, filtering, and taking a subsequent filtrate as the test substance solution.

The injection sequence and requirements are shown in the table below.

Injection sequence

| Sequence | Samples | Injections |
|---|---|---|
| 1 | Blank solution | 1 injection |
| 2 | Reference substance solution | 5 injections (continuous tests) |
| 3 | Test substance-0 h | 1 injection |
| 4 | Test substance-4 h | 1 injection |
| 5 | Test substance-8 h | 1 injection |
| 6 | Test substance-12 h | 1 injection |
| 7 | Test substance-18 h | 1 injection |
| 8 | Test substance-24 h | 1 injection |
| 9 | Test substance (double time) | 1 injection |
| 10 | Reference substance solution | 1 injection |

(2) Result Report

Based on the stability chromatogram and using the same processing method as the sample, the similarity is calculated using the “Similarity Evaluation System for Traditional Chinese Medicine Chromatographic Fingerprint”. The relative retention time and relative peak area are calculated using peak 6 (D-glucose anhydrous) as a reference. (Refer to FIGS. 6-7)

TABLE 2.4-1
Stable common peak pattern similarity results

| / | | Similarity | | | | | |
|---|---|---|---|---|---|---|---|
| Test substance | | 0 h | 4 h | 8 h | 12 h | 16 h | 24 h |
| 0 | h | 1.000 | 0.999 | 0.997 | 0.997 | 0.996 | 0.995 |
| 4 | h | 0.999 | 1.000 | 0.999 | 0.999 | 0.999 | 0.998 |
| 8 | h | 0.997 | 0.999 | 1.000 | 0.999 | 0.999 | 0.998 |
| 12 | h | 0.997 | 0.999 | 0.999 | 1.000 | 0.999 | 0.998 |
| 16 | h | 0.996 | 0.999 | 0.999 | 0.999 | 1.000 | 1.000 |
| 24 | h | 0.995 | 0.998 | 0.998 | 0.998 | 1.000 | 1.000 |

| | | | | | | |
|---|---|---|---|---|---|---|
| R | 0.994 | 0.997 | 0.998 | 0.998 | 1.000 | 1.000 |

TABLE 2.4-2
Results of relative retention time of stable common peaks

| / | Relative Retention time | | | | | | |
|---|---|---|---|---|---|---|---|
| Test substance | 0 h | 4 h | 8 h | 12 h | 16 h | 24 h | RSD (%) |
| Common | 0.13 | 0.13 | 0.13 | 0.13 | 0.13 | 0.13 | 0.16 |
| peak-1 | | | | | | | |
| Common | 0.14 | 0.14 | 0.14 | 0.14 | 0.14 | 0.14 | 0.25 |
| peak-2 | | | | | | | |
| Common | 0.17 | 0.17 | 0.17 | 0.17 | 0.17 | 0.17 | 0.05 |
| peak-3 | | | | | | | |
| Common | 0.69 | 0.69 | 0.69 | 0.69 | 0.69 | 0.69 | 0.20 |
| peak-4 | | | | | | | |
| Common | 0.72 | 0.72 | 0.73 | 0.72 | 0.72 | 0.72 | 0.13 |
| peak-5 | | | | | | | |
| Common | 1.00 | 1.00 | 1.00 | 1.00 | 1.00 | 1.00 | 0.00 |
| peak-6 | | | | | | | |
| Common | 1.14 | 1.14 | 1.14 | 1.14 | 1.14 | 1.14 | 1.14 |
| peak-7 | | | | | | | |

TABLE 2.4-3
Stable common peak relative peak area results

| / | Relative Retention time (%) | | | | | | |
|---|---|---|---|---|---|---|---|
| Test substance | 0 h | 4 h | 8 h | 12 h | 16 h | 24 h | RSD (%) |
| Common | 1.32 | 1.62 | 1.36 | 1.26 | 1.24 | 1.22 | 10.11 |
| peak-1 | | | | | | | |
| Common | 6.67 | 5.99 | 5.98 | 8.74 | 5.41 | 7.70 | 16.95 |
| peak-2 | | | | | | | |
| Common | 2.54 | 2.98 | 2.57 | 2.59 | 2.55 | 2.57 | 5.93 |
| peak-3 | | | | | | | |
| Common | 2.23 | 2.21 | 2.15 | 2.30 | 2.25 | 2.24 | 2.06 |
| peak-4 | | | | | | | |
| Common | 9.68 | 10.20 | 10.28 | 10.61 | 10.24 | 10.31 | 2.69 |
| peak-5 | | | | | | | |
| Common | 1.00 | 1.00 | 1.00 | 1.00 | 1.00 | 1.00 | 0.00 |
| peak-6 | | | | | | | |
| Common | 0.17 | 0.17 | 0.16 | 0.17 | 0.16 | 0.17 | 1.62 |
| peak-7 | | | | | | | |

(3) Conclusion

From the results, it can be seen that the similarity of the test substance is greater than 0.99 within 24 hours, the relative retention time (RSD) of each common peak is less than 2.0, and the peak area (RSD) is less than 10.0%. Therefore, the test substance is stable within 24 hours. There is no peak in the chromatogram in the double time condition, showing good results.

### Example 3 Investigation of Different Chromatographic Conditions

In order to obtain the detection method according to the present application, this experiment investigated and screened chromatographic columns, mobile phases and gradients, column temperature, flow rate, temperature, etc. in the detection method, as detailed in the following text. Other methods and conditions in this experiment are referred to the operations in Examples 1 and 2.

3.1 Investigation of Different Chromatographic Columns

(1) Experimental Steps

Chromatographic Conditions:

Three different chromatographic columns, Waters Xbridge Amide (3.5 μm), are investigated separately μm, 4.6 mm×250 mm), TechMate NH₂-ST (5 μm 80 A 4.6×250 mm), Prevail Carbo hydrate ES column (5 μm, 4.6 mm×250 mm);

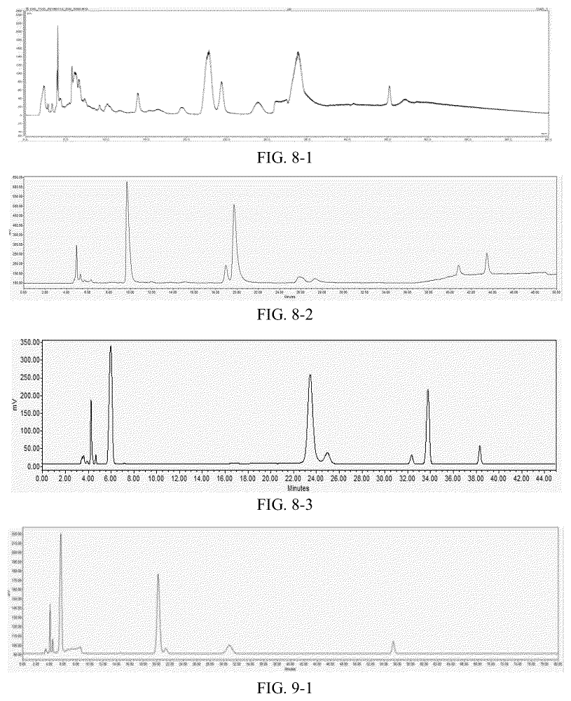

(2) Results of Experiments

| Chromatographic column | Chromatogram |
|---|---|
| Waters Xbridge Amide (3.5 μm, 4.6 mm × | Referring to FIG. 8-1 |
| 250 mm) | |
| TechMate NH2-ST (5 μm 80A 4.6*250 mm) | Referring to FIG. 8-2 |
| Prevail Carbo-hydrate ES column (5 μm, 4.6 | Referring to FIG. 8-3 |
| mm × 250 mm) | |

Considering the separation degree, the baseline noise, and the chromatographic peak pattern, the optimal chromatographic column is the Prevail Carbo hydrogen ES column with a diameter of 4.6 mm×250 mm and 5 μm Sel No. J2910088.

3.2 Investigation of Different Mobile Phase Gradients

(1) Four Different Mobile Phase Gradients are Investigated, with Mobile Phase D being Acetonitrile and Mobile Phase C being Water

| | Mobile phase gradient | | | |
|---|---|---|---|---|
| | | Mobile | Mobile | Flow rate |
| | Time (min) | phase C (%) | phase D (%) | (ml/min) |
| Gradient 1 | 0-80 | 15 | 85 | 1 |
| Gradient 2 | 0-8 | 22-15 | 78-85 | 1 |
| | 8-12 | 15 | 85 | 0.5 |
| | 12-20 | 15-22 | 85-78 | 0.5 |
| | 20-25 | 22 | 78 | 1 |
| | 25-50 | 22 | 78 | 1 |
| Gradient 3 | 0-40 | 15 | 85 | 0.5 |
| | 40-45 | 15-25 | 85-75 | 0.5-1 |
| | 35-50 | 25 | 75 | 1 |
| Gradient 4 | 0-25 | 15 | 85 | 1 |
| | 25-30 | 15-25 | 85-75 | 1 |
| | 30-45 | 25 | 75 | 1 |

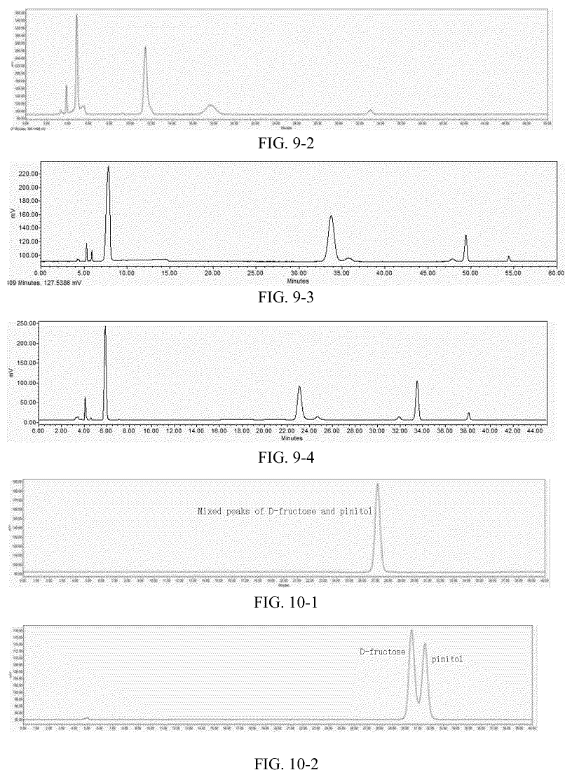

(2) Results of Experiments

| Gradient elution | Chromatogram |
|---|---|
| Gradient 1 | Referring to FIG. 9-1 |
| Gradient 2 | Referring to FIG. 9-2 |
| Gradient 3 | Referring to FIG. 9-3 |
| Gradient 4 | Referring to FIG. 9-4 |

The separation degree of fructose and pinitol is investigated as an indicator, and the optimized mobile phase gradient 4 is the optimal mobile phase gradient condition.

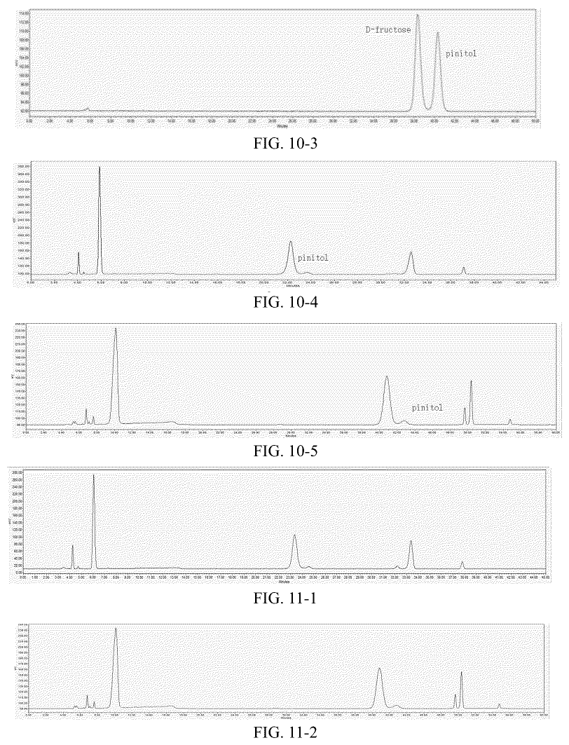

3.3 Investigation of Different Column Temperatures
(1) Five different column temperatures are investigated: 35° C., 25° C., 20° C., 15° C., and 13° C.;
(2) Results of experiments

| Column temperature | Chromatogram |
|---|---|
| 35° C. | Referring to FIG. 10-1 |
| (Mixed reference substances) | |
| 25° C. | Referring to FIG. 10-2 |
| (Mixed reference substances) | |
| 20° C. | Referring to FIG. 10-3 |
| (Mixed reference substances) | |
| 15° C. | Referring to FIG. 10-4 |
| (Injection sample) | |
| 13° C. | Referring to FIG. 10-5 |
| (Injection sample) | |

In summary, by investigating the column temperature of 13° C.-35° C., it can be concluded that when the temperature is low, the separation of fructose and pinitol is good. Considering the instrument and surrounding environment, the column temperature is tentatively set at 15° C.

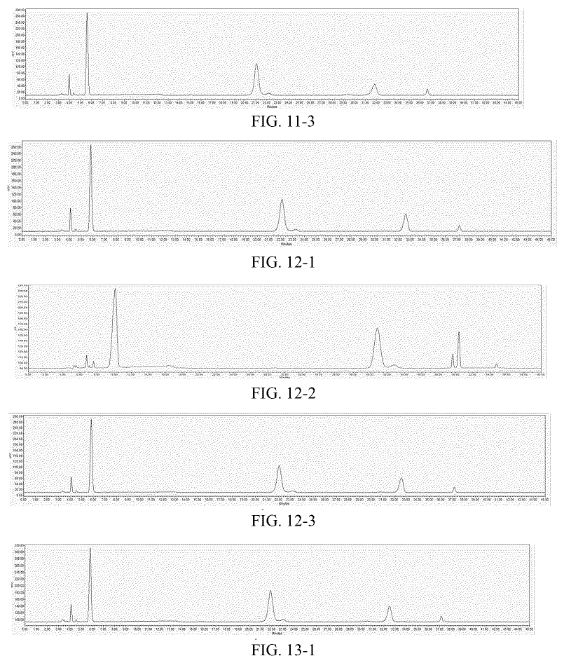

3.4 Investigation of Different Flow Rates
(1) Three different flow rates are investigated: 0.95 ml/min, 1 ml/ml, and 1.05 ml/min;
(2) Results of experiments

| Flow rate | | Separation degree between D- |
|---|---|---|
| (ml/min) | Chromatogram | fructose and pinitol |
| 0.95 | Referring to FIG. 11-1 | 1.84 |
| 1 | Referring to FIG. 11-2 | 1.77 |
| 1.05 | Referring to FIG. 11-3 | 1.78 |

| | |
|---|---|
| RSD(%) | 1.72 |

In summary, by investigating flow rate, it can be seen that the flow rate has no significant effect on the peak pattern of the chromatogram. The RSD of separation degree between D-fructose and pinitol under various conditions is 1.72%, with no significant difference. Therefore, the flow rate is set at 1 ml/min.

3.5 Investigation of Different Evaporation Temperatures
(1) Three different evaporation temperatures are investigated: 59° C., 60° C., and 61° C.;
(2) Results of experiments

| Evaporating | | Separation degree between |
|---|---|---|
| temperature ° C. | Chromatogram | D-fructose and Pinitol |
| 59 | Referring to FIG. 12-1 | 1.78 |
| 60 | Referring to FIG. 12-2 | 1.77 |
| 61 | Referring to FIG. 12-3 | 1.77 |

| | |
|---|---|
| RSD (%) | 0.27 |

In summary, by investigating evaporation temperature, it can be seen that the evaporation temperature has no significant effect on the peak pattern of the chromatogram. The separation degree RSD of D-fructose and pinitol under various conditions is 0.27%, and there is no significant difference. Therefore, the evaporation temperature is set at 60° C.

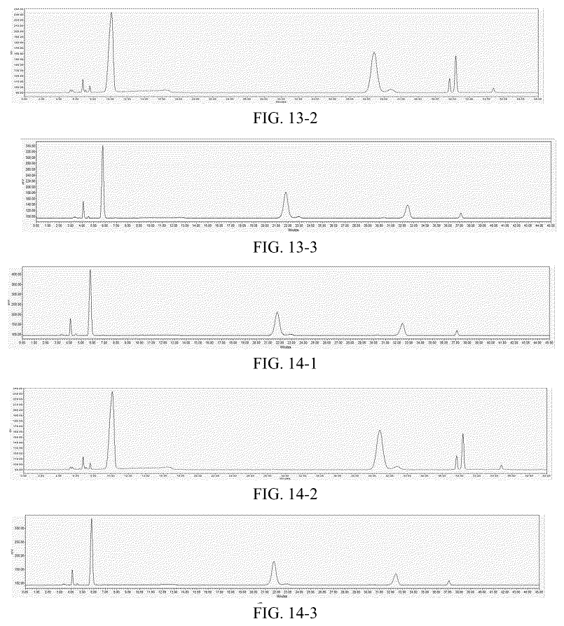

3.6 Investigation of Different Atomization Temperatures
(1) Three different atomization temperatures are investigated: 59° C., 60° C., and 61° C.;
(2) Results of experiments

| Atomizing | | Separation degree between |
|---|---|---|
| temperature ° C. | Chromatogram | D-fructose and Pinitol |
| 59 | Referring to FIG. 13-1 | 1.66 |
| 60 | Referring to FIG. 13-2 | 1.77 |
| 61 | Referring to FIG. 13-3 | 1.74 |

| | |
|---|---|
| RSD (%) | 2.69 |

In summary, by investigating evaporation temperature, it can be seen that the atomization temperature has no significant effect on the peak pattern of the chromatogram. The separation degree RSD of D-fructose and pinitol under various conditions is 2.69%, with no significant difference. Therefore, the atomization temperature is set at 60° C.

3.7 Investigation of Different Flow Rate of Carrier Gas

(1) Three Different Flow Rate of Carrier Gas are Investigated: 1.4 L/min, 1.5 L/ml, and 1.6 L/min;

The other chromatographic conditions are:

(2) Results of Experiments

| Flow rate of carrier | | Separation degreen between |
|---|---|---|
| gas (L/min) | Chromatogram | D-fructose and pinitol |
| 1.4 | Referring to FIG. 14-1 | 1.68 |
| 1.5 | Referring to FIG. 14-2 | 1.77 |
| 1.6 | Referring to FIG. 14-3 | 1.71 |

| | |
|---|---|
| RSD (%) | 2.18 |

In summary, by investigating flow rate of carrier gas, it can be seen that the flow rate of carrier gas has no significant effect on the peak pattern of the chromatogram. The RSD of the separation between D-fructose and pinitol under various conditions is 2.18%, with no significant difference. Therefore, the flow rate of carrier gas is set at 1.5 L/min.

1. A method for detecting content and fingerprint of monosaccharide in Compound Kushen Injection, comprising: performing detection by using a high-performance liquid chromatography-evaporative light scattering detection method, wherein the monosaccharide comprises D-glucose anhydrous, D-fructose, sucrose, and pinitol.

2. The method according to claim 1, wherein the chromatographic column in the high-performance liquid chromatography-evaporative light scattering detection method is a Prevail Carbo hydrogen ES column with a specification of 4.6 mm×250 mm and 5 μm.

3. The method according to claim 1, wherein the mobile phase in the high-performance liquid chromatography-evaporative light scattering detection method is a gradient solution of acetonitrile and water.

4. The method according to claim 3, wherein the gradient elution conditions in the high-performance liquid chromatography-evaporative light scattering detection method are:

| Time (min) | Acetonitrile (%) | Water (%) |
|---|---|---|
| 0-25 | 85 | 15 |
| 25-30 | 85-70 | 15-30 |
| 30-45 | 70 | 30 |

5. The method according to claim 3, wherein a flow rate of the mobile phase in the high-performance liquid chromatography-evaporative light scattering detection method is 0.95-1.05 ml/min, preferably 1 ml/min.

6. The method according to claim 1, wherein the column temperature in the high performance liquid chromatography-evaporative light scattering detection method is 13° C. to 20° C., preferably 15° C.

7. The method according to claim 1, wherein an injection amount in the high-performance liquid chromatography-evaporative light scattering detection method is 10 μL or 20 μl.

8. The method according to claim 1, wherein the evaporation temperature of the evaporation light detector in the high-performance liquid chromatography-evaporative light scattering detection method is 59-61° C., preferably 60° C.

9. The method according to claim 1, wherein an Atomizing temperature of the evaporation light detector in the high-performance liquid chromatography-evaporative light scattering detection method is 59-61° C., preferably 60° C.

10. The method according to claim 1, wherein a carrier gas in the high-performance liquid chromatography-evaporative light scattering detection method is nitrogen, with a flow rate of 1.4-1.6 L/min, preferably 1.5 L/min.

11. The method according to claim 1, wherein a blank solution in the high-performance liquid chromatography-evaporative light scattering detection method is prepared from a mixed solution of acetonitrile-water=50:50.

12. The method according to claim 1, wherein the preparation of a reference substance solution in the high-performance liquid chromatography-evaporative light scattering detection method comprises: accurately weighing an appropriate amount of D-fructose reference substance, pinitol reference substance, D-glucose anhydrous reference substance, and sucrose reference substance, adding a blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking.

13. The method according to claim 1, wherein the preparation of the test substance solution in the high-performance liquid chromatography-evaporative light scattering detection method comprises accurately weighing 1 ml of individual batches of Compound Kushen Injection, adding to a 20 ml volumetric flask, adding a blank solution to scale, shaking, filtering, and taking a subsequent filtrate as the test substance solution.

14. A method for detecting the content of monosaccharide in Compound Kushen Injection according to claim 1, wherein the method comprises performing detection by using a high-performance liquid chromatography-evaporative light scattering detection method, and wherein the conditions for high-performance liquid chromatography evaporative light scattering are:

| Chromatographic | Prevail Carbo-hydrate ES column, 4.6 mm × | | |
|---|---|---|---|
| column | 250 mm, 5 μm | | |
| Mobile phase | Acetonitrile-water gradient elution | | |
| Elution conditions | Time (min) | Acetonitrile (%) | Water (%) |
| | 0-25 | 85 | 15 |
| | 25-30 | 85-70 | 15-30 |
| | 30-45 | 70 | 30 |
| | |
|---|---|
| Column temperature | 15° C. |
| Flow rate | 1 ml/min |
| Detector | Evaporative light scattering detector (ELSD) |
| Evaporating | 60° C. |
| temperature | |
| Atomizing | 60° C. |
| temperature | |
| Flow rate of carrier | 1.5 L/min |
| gas (N2) | |

(1) Preparation of blank solution: preparing acetonitrile and water=50:50 mixed solution;
(2) Preparation of reference substance solution: accurately weighing an appropriate amount of D-fructose reference substance, pinitol reference substance, D-glucose anhydrous reference substance, and sucrose reference substance, adding a blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking, which is obtained;
(3) Preparation of test substance solution: accurately weighing 1 ml of Compound Kushen Injection, adding to a 20 ml volumetric flask, adding the blank solution to scale, shaking, filtering, and taking a subsequent filtrate as the test substance solution; and
(4) Detection: injecting samples in the order of blank solution, reference substance solution, and test substance solution, and calculating contents of D-fructose, pinitol, D-glucose anhydrous, and sucrose in the test substance by a two-point external standard method.

15. A method for detecting a fingerprint of Compound Kushen Injection according to claim 1, wherein the method comprises constructing a fingerprint of Compound Kushen Injection containing D-glucose anhydrous, D-fructose, sucrose, and pinitol.

16. The method according to claim 15, wherein the method comprises: performing detection by using a high performance liquid chromatography-evaporative light scattering method, wherein the conditions for high performance liquid chromatography evaporative light scattering detection are:

| Chromatographic | Prevail Carbo-hydrate ES column, 4.6 mm × | | |
|---|---|---|---|
| column | 250 mm, 5 μm | | |
| Mobile phase | Acetonitrile-water gradient elution | | |
| Elution conditions | Time (min) | Acetonitrile (%) | Water (%) |
| | 0-25 | 85 | 15 |
| | 25-30 | 85-70 | 15-30 |
| | 30-45 | 70 | 30 |
| | |
|---|---|
| Column temperature | 15° C. |
| Flow rate | 1 ml/min |
| Detector | Evaporative light scattering detector (ELSD) |
| Evaporating | 60° C. |
| temperature | |
| Atomizing | 60° C. |
| temperature | |
| Flow rate of carrier | 1.5 L/min |
| gas (N2) | |

(1) Preparation of a blank solution: preparing acetonitrile and water=50:50 mixed solution;
(2) Preparation of reference substance solution: accurately weighing an appropriate amount of D-fructose reference substance, pinitol reference substance, D-glucose anhydrous reference substance, and sucrose reference substance, adding the blank solution to prepare a mixed reference substance solution containing 1.00 mg of D-fructose, 0.19 mg of pinitol, 0.90 mg of D-glucose anhydrous, and 0.20 mg of sucrose per 1 ml, and shaking; and preparing two copies using the same method;
(3) Preparation of test substance solution: accurately weighing 1 ml of Compound Kushen Injection, adding to a 20 ml volumetric flask, adding the blank solution to scale, shaking, filtering, and taking a subsequent filtrate as the test substance solution;
(4) Construction of a standard fingerprint spectrum: injecting samples in the order of blank solution, reference substance solution, and test substance solution to construct a standard fingerprint spectrum of Compound Kushen Injection containing D-glucose anhydrous, D-fructose, sucrose, and pinitol; and
(5) Detection: injecting samples in the order of blank solution, reference substance solution, and test substance solution, and calculating contents of D-fructose, pinitol, D-glucose anhydrous, and sucrose in the test substance by using a two-point external standard method.

17. The method according to claim 16, wherein the standard fingerprint comprises three unknown peaks, a D-fructose chromatographic peak, a pinitol chromatographic peak, a D-glucose anhydrous chromatographic peak, and a sucrose chromatographic peak.

18. The method according to claim 17, wherein the standard fingerprint, relative retention times of three unknown peaks are 0.100-0.130, preferably 0.12; 0.135-0.150, preferably 0.14; 0.170-0.190, preferably 0.18; the relative retention time of D-fructose is 0.660-0.690, preferably 0.67; the relative retention time of pinitol is 0.695-0.730, preferably 0.70; the relative retention time of D-glucose anhydrous is 1.00; and the relative retention time of sucrose is 1.130-1.153, preferably 1.14.
